(19) United States
(12) Patent Application Publication
(10) Pub. No.: US 2023/0177636 A1
(43) Pub. Date: Jun. 8, 2023

(54) METHOD TO PERFORM COMPUTATION AT OR NEAR THE SPEED OF LIGHT (TYPICAL) DIGITAL IMAGE-TO-BINARY SINGULAR OR MULTIPLE-NODES/SERVERS AND COMPUTER ARCHITECTURE

(71) Applicant: Luis Manuel CABRITA PAIS HOMEM, Lisbon (PT)

(72) Inventor: Luis Manuel CABRITA PAIS HOMEM, Lisbon (PT)

(21) Appl. No.: 17/997,391

(22) PCT Filed: May 18, 2021
(86) PCT No.: PCT/PT2021/050014

§ 371 Date: Oct. 28, 2022

(30) Foreign Application Priority Data
May 20, 2020 (PT) 116408

(51) Int. Cl. G06T 1/20

(52) U.S. Cl. CPC G06T 1/20

(57) ABSTRACT

A method of performing computation at or near the speed of light (typical) digital image-to-binary Computer Architecture (CA), which is the pixel or any “pixel”-like exponential-prone basis single “cell” in a digital image including numeric representation, and having the following steps referred to the digital images and their processing: conversion of (typical) digital images (9,1); impression memory (9.2); processing of numerical data/metadata (9.3); well-ordering recollection (9.4); well-ordering collection (9.5); reimpression memory (9.6); and programming processing of algorithms (9.7). The method of the invention that we choose to call U-Mentalism, imposes a massive parallel (typical) digital CA, settled on many nodes/servers camera/image processing Universal Turing Machines over Turing or computing machines (M), with many “films” made of many “frames” or “synthesis” of (digital) images. The consequences are exponential improvement in threading and computing capacity.

### TECHNICAL FIELD

The present invention refers to a method and a CA of massive parallel super-computation achieved with intense resource to (typical) digital images, being image-to-binary processed at each node/server of a communications network, on or out of the Internet, of camera/image processing Universal Turing-machines over Turing-machines. The proposed method combines ideas mainly from the very broad field of natural philosophy, conceivably named philosophy of science.

### BACKGROUND ART

Considering the structural and functional use of direct processing of a continuum of images, or as it may be imagetic configurations in physical and informational sense impressions, either in typical M or computing machine, or as it may be a single Universal Turing-machine, or preferably in as many as possible distributed and partial U-machines over a network of Turing-machines, on or outside of the Internet, the prior art comprises the von Neumann's “iconoscope memory” technology.

### SUMMARY OF INVENTION

The present invention refers to a method to perform computation at or near the speed of light (typical) digital image-to-binary Computer Architecture (CA), which is the pixel or any “pixel”-like exponential-prone basis single “cell” in a digital image including numeric representation, and comprising the following steps:
a. Conversion of (typical) digital images (3) to a predetermined density of the pixel equation, or image resolution, resulting in a set of converted digital images (9.1);
b. Impression memory of image/text RGB/binary “pixel”-like isomorphic (typical) digital images allocated in numerical data or metadata, resulting in a set of allocated numerical data or metadata (9.2);
c. Processing of the image/text RGB/binary isomorphic allocated numerical data or metadata of the (typical) digital images, resulting in a set of processed digital images (9.3);
d. Well-ordering recollection of the image/text RGB/binary isomorphic processed (typical) digital images from the least-to-the-furthest well-ordered numeric representation of the digital images, resulting in a set of well-ordered digital images composition (9.4), and whenever computation prerequisites only recollection well-orderings can be reimpressed (9.6);
e. Well-ordering collection of the image/text RGB/binary isomorphic processed (typical) digital images from the least-to-the-furthest numerical and algorithmic representation, resulting in a set of well-ordered digital images collection (9.5);
f. Reimpression of the image/text RGB/binary isomorphic processed and well-ordered (typical) digital images, resulting in numerical data or metadata (9.6);
g. Programming processing of image/text RGB/binary isomorphic processed and well-ordered algorithms based in numerical data or metadata (9.7); and wherein the numeric representation of the (typical) digital image (3) is always RGB/binary or “pixel”-like photon/binary code isomorphic with the imagetic information, such as in the state of the art the RGB image/text colour model; and wherein the steps a) is executed by a Turing-machine (M) to Universal Turing-machine (UTM) protocol, or Universal Turing-machine (UMT) protocol only and b) is executed by an Universal Turing-machine (UTM) to Turing-machine (M) protocol and Universal Turing-machine (UTM) protocol only; and wherein the steps c), d), e), f), and g) are executed by an Universal Turing Machine (UTM) to Universal Turing-machine (UTM) protocol; and wherein computation is performed at each node/server in a communication network of Universal Turing Machines (UTMs) over Turing Machines (Ms) in a) to g) loop massive parallel computation.

The present invention refers to computer architecture to perform computation at or near the speed of light, is characterized by the “synthesis” of the pixel or any “pixel”-like exponential-prone basis “cell” in the digital image, wherein said digital image includes numeric representation, and comprises the following instructions:
a. Conversion of (typical) digital images (3) to a predetermined density of the pixel equation, or image resolution, resulting in a set of converted digital images (9.1);
b. Impression memory of image/text RGB/binary “pixel”-like isomorphic (typical) digital images allocated in numerical data or metadata, resulting in a set of allocated numerical data or metadata (9.2);
c. Processing of the image/text RGB/binary isomorphic allocated numerical data or metadata of the (typical) digital images, resulting in a set of processed digital images (9.3);
d. Well-ordering recollection of the image/text RGB/binary isomorphic processed (typical) digital images from the least-to-the-furthest well-ordered numeric representation of the digital images, resulting in a set of well-ordered digital images composition (9.4), and whenever computation prerequisites only recollection well-orderings can be reimpressed (9.6);
e. Well-ordering collection of the image/text RGB/binary isomorphic processed (typical) digital images from the least-to-the-furthest numerical and algorithmic representation, resulting in a set of well-ordered digital images collection (9.5);
f. Reimpression of the image/text RGB/binary isomorphic processed and well-ordered (typical) digital images, resulting in numerical data or metadata (9.6);
g. Programming processing of image/text RGB/binary isomorphic processed and well-ordered algorithms based in numerical data or metadata (9.7); and
   wherein the numeric representation of the (typical) digital image is always RGB/binary or “pixel”-like photon/binary code isomorphic with the imagetic information, such as in the state of the art the RGB image/text colour model; and
   wherein the steps a) is executed by a Turing-machine (M) to Universal Turing-machine (UTM) protocol, or Universal Turing-machine (UTM) protocol only and b) is executed by an Universal Turing-machine (UTM) to Turing-machine (M) protocol and Universal Turing-machine (UTM) protocol only; and
   wherein the steps c), d), e), f), and g) are executed by an Universal Turing Machine (UTM) to Universal Turing-machine (UTM) protocol; and wherein computation is performed at each node/server in a communication network of Universal Turing Machines (UTMs) over Turing Machines (Ms) in a) to g) loop massive parallel computation.

### Technical Problem

A limitation of the von Neumann's “iconoscope memory” technology is the lack of coverage and technological range, which is based on the pre-LCD cathode ray tube.

Moreover, there exists a great interest and need to develop a method and a CA that contributes to a structural and functional use of direct processing of a continuum of images having an increased processing performance.

### Solution to Problem

The present invention imposes a massive parallel (typical) digital image CA, settled on many nodes/servers camera/image processing UTM(s) over M(s), with many “films” made of many “frames” or image-to-binary “synthesis” of (typical) digital images, which comprises the “pixel”, or any “pixel”-like exponential-prone basis cell in a (typical) digital image, or electromagnetic wavelike “packets”, fitted to quantum computing, wherein said (typical) digital image include numeric representation.

### Advantageous Effects of Invention

The advantageous effects of the invention are a dramatic and truly exponential, not merely incremental, improvement in threading and computing capacity. Although (typical) digital images can be generated through machine learning techniques, the feed-in stacks should result, in large majority, from extant (digital) images, comprehensively achieving a great gain and savings in many types of memory and an exponential factor improvement in processing performance.

### BRIEF DESCRIPTION OF DRAWINGS

With the purpose of promoting an understanding of the principles in accordance with the embodiments of the present invention, reference will be made to the embodiments illustrated in the figures and to the language used to describe the same. Anyway, it must be understood that there is no intention of limiting the scope of the present invention to the contents of the FIGURES. Any alterations or later changes of the inventive features illustrated herein and any additional application of the principles and embodiments of the invention shown, which would occur normally for one skilled in the art when reading this description, are considered as being within the scope of the claimed invention.

FIG. 1 illustrates the entire overview image.

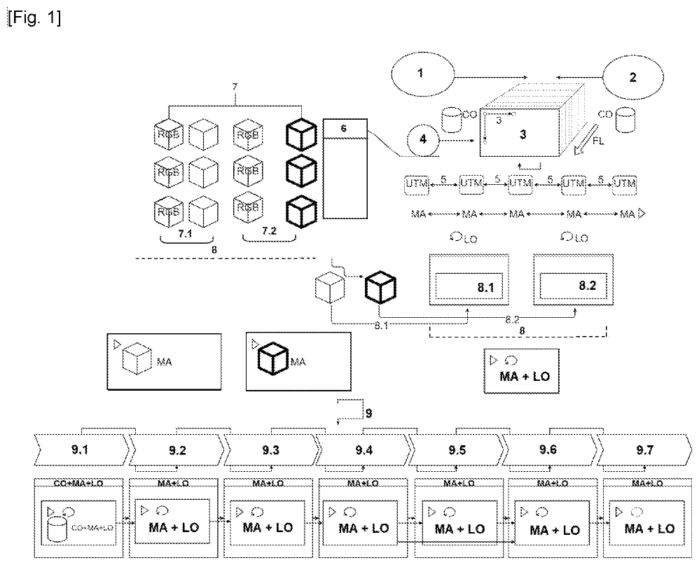

### DESCRIPTION OF EMBODIMENTS

The invention herein disposed is, at large, a new Computer Architecture (CA), with great consequences in network and internet communications. With this we mean that it is an unpublished and original computer organization and design, in terms of hardware and software interface. More importantly, it converges symbolic innovation, as found in instruction set design (ISD), and implementation, as found in integrated circuit design (ICD), packaging and power, in the sense that the proposed shift in symbolic terms unavoidably alters the cybernetic applicable and materialized system as a whole. The range of this unavoidable alteration is made influent to the largest possible extent, i.e., from mainstream computing classes and inherent system characteristics, network communication systems and internet protocols, programming languages design, up to overall cybernetic scalability, power, and efficiency. Nevertheless, the proposed system is also designed to dialogue with the actual state of the art technology, enabling a smooth, ever-evolving overall convolution. Also relevant to this point is the idea that the referred invention hinges on a common symbolic substratum for both typical image processing in graphic processing units (GPUs), and more general-purpose central processing units (CPUs), as well as on the common ground of highly massive parallel (MA) computation and more linear centralized structures, which also explains the technical conveyance between a CA and an algorithm.

The present invention comprises a symbolic model (SM) and an instruction set architecture (ISA) or CA, for general-purpose and high-level performance computers, either single or interconnected with communication networks, on or outside of the Internet. It, thus, complies a set of rules and methods coherent not only with any computable sequences performed by any computing machine or M, but also with the model of a Universal Turing-Machine (UTM or U-machine). Further information of U-machines is present in Turing, A. M. On Computable Numbers, with an Application to the Entscheidungs problem. (1936).

The invention herein presented settles to extend the solvability and, indeed, convey practical fully deployable solutions pertaining to the symbolic system, functional organization, logic design and overall implementation of computer science classical defined problems, beyond already very expressive improvements of power, speed, and memory on its own.

Indeed, by asserting singular or multiple nodes/servers (typical) digital image-to-binary CA—most preferably in the model of an U-machine, as opposed to a Turing-machine (TM)—either single or interconnected with communication networks, on or outside of the Internet, the invention imposes an operative positive shift over the so called “von Neumann bottleneck”, wherein further details about it are described in Backus, John W. Can Programming Be Liberated from the von Neumann Style? A Functional Style and Its Algebra of Programs. (1977). Moreover, the invention also imposes a new intrinsic super-computation model to work thoroughly computational complexity classes boundaries and scope.

In respect to the “von Neumann bottleneck”, the invention, as an alternative CA relative to von Neumann's, brings in a concurrent parallel to the binary code symbolic system, which we define as the “synthesis” of the (typical) digital image, all in all working as U-machine(s) towards every possible existent Turing-machine. The (typical) digital image is, henceforth, processed as an isomorphic copy of the binary code in the original (typical) digital image, in all its possible differences and repetitions, now with the pivotal change that in every single network node/server correspondent to a camera/computer processor, both the “pixel” and the “synthesis” of the image itself or their “frames” are now the new minimal physical patterns (symbols). In the preferred embodiments, each single network node/server works as a partial U-machine. These symbols are combined into isomorphic-to-the-binary code structures (expressions), hence able to be manipulated (processes) to factor new expressions.

“Synthesis” is here understood in abstract terms as in Kant [Synthesis, Verbindung]: “By synthesis, in its most general sense, I understand the act of putting different representations together, and of grasping what is manifold in them in one act of knowledge” (A77/B 103, Critique of Pure Reason, 1781), i.e., the act of bringing together and combining any manifold given in intuition to effectively produce knowledge. Once what is determinant for the case being of this invention is that the knowledge be materialized, one such combination is to be correlatively understood as one may found in Ada Lovelace's Note G on her translation of Luigi Menabrea's paper on Charles Babbage's Analytical Engine: “For, in so distributing and combining the truths and the formula of analysis, that they may become most easily and rapidly amenable to the mechanical combinations of the engine, the relations and the nature of many subjects in that science are necessarily thrown into new lights, and more profoundly investigated.” (Taylor's Scientific Memoirs, 1842-43). Thus, that these combinations or “synthesis” are made amenable to be engineered is the fundamental agreement on both by the chosen expression.

As expanded before, in accordance with the concept of “synthesis”, there are distinctive many-levels of “synthesis” in the “system”. In developing the description of the “system”, it is fairly viable to equate the aforementioned many different “synthesis” with the classical concepts of a Turing-machine. We choose to expand this topic by pointing out each concept in upward progressive order of magnitude. The “cell” is related, in its minimal form, to whichever dimensionless logical units, herein considered as “pixels” in any “(typical) digital images”, which hold, in RGB/binary form, typically 3 bytes of RGB colour information. The nearest neighboring relation in any form of read-in, presumably from top left-to-right to bottom left-to-right as the original cathode ray tubes and occidental writing systems, are to settle the discrete showcase of “pixels” in the rendered section of the (FPS) (Frames Per Second) digital image “frame”, thus considering it as the smallest addressable and representable element in the (FPS) “frame”, independently of the resolution, pixmap raster or vector types, or ahead, independently of forthcoming suitable quanta information in “pixel”-like or, more largely, “cell”-like packet waveform.

Notwithstanding, on such top left-to-right, bottom left-to-right orientation of the “(typical) digital image” read-in should be transformed, in the present invention, to the typical simultaneous orthogonal and synchronous graphical impression on digital sensors, herein of “scanner” type. Resultantly, because UTM(s) produce the read-in RGB/binary form, the minimal unit is, therefore, for the time being, the “octet”-“byte”, which is comprised within the “pixel” itself. Following, in abstract terms, the “cell” is leveraged to the “pixel”, alternatively, the 3 “octet”-3 “byte”. Thereafter, the “cell”, herein the “pixel”, is leveraged to the (FPS) “frame” of the “(typical) digital image”. It is relevant to remind that in terms of processing, all of the previous are coeval, i.e., synchronous and endowed with orthogonality. At this point, the use of the term “cell” can be equated with the idea of, non-literally, “square”, as used by Turing in abstract terms. At this instant also, a whole shift occurs, once the many (FPS) “synthesis” of “(typical) digital images” as “squares” of the “tape”, in Turing's lexicon, are now, with the present invention, “film” or the “movement-image”, with an exponential bearing of the symbol thereof described. At last, because with the present invention are involved many different “films” and possible different impending “scanner-to-printer” or “Eye-to-Brain “recollections” (STEP d, 9.4), and “printer-to-scanner” or “Brain-to-Eye” “collections” (STEP e, 9.5), the next to consider “synthesis” are, thereafter, every possible “synthesis” of well-ordering “recollection” “compositions” (STEP d; 9.4), as well as every possible “synthesis” of well-ordering “collection” “permutation/combination” (STEP e, 9.5), with endless limits of applicability.

As it is illustrated in 3, a (typical) digital image is formed by means of at or near the speed of light (typical) digital image-to-binary singular or multiple nodes CA process, wherein said process comprises inputs from (1) the network of communications, preferably on the Internet data, in the form of image/text “pixel”-composed images or general image sensing; and also inputs from (2) the network of communications, preferably on the Internet, AI & Cryptography data, in the form of image/text “pixel”-permuted/combined images or general image processing; and also comprises a step of flux of the films (FL) to the camera processing nodes/servers (5).

In what follows is best described the many different “synthesis” of “(typical) digital images” (3) “scanner-to-printer” or “Eye-to-Brain” “well-ordered recollection” (STEP d, 9.4) composition on one side, and “printer-to-scanner” or “Brain-to-Eye” well-ordered “permutation/combination” (STEP e, 9.5) on the other side. We have to welcome the mathematically well-defined model theory concepts of composition, and also of both permutation and combination to this effect. Because the RGB/binary system is isomorphic with any order of magnitude arithmetic system, each and every “pixel”, “frame”, or “film” is said to be an RGB/binary number. Now, it is the role of the “well-ordering recollection” (STEP d, 9.4) in UTM(s) to first cite and recollect from the extant network of communications, preferably on the Internet, “(typical) digital images” (3). These are, as shown in “Internet data: image/text” “pixel”-composed, independently of previous applied on cryptography methods. Muck like the sieve of Eratosthenes algorithm, there will be intervals in the equivalent and isomorphic arithmetic RGB/binary large numbers, either in modules, “frames”, or “films”. From this point on, and bearing in mind that the simplest search algorithm is, at each step, N+1 XOR N−1, is set in motion the first of many repeated facet of “well ordering” “permutation/combination” (STEP e, 9.5), which is to actively, as a “collection” of “(typical) digital images”, generate and process new “data: image/text” in UTM(s). Because each new “(typical) digital image” ought to be cryptographed, and because the cryptographic method and distributivity in the network can mask the original RGB/Binary number of the “frame” or “film”, these processes have the extraordinary ability to be also simultaneous, even if we have to consider them abstractly separated. More and more large numbers of modules, “frames”, and “films” are, in this way, “well-ordered”, something that is shared between both (STEPS d, e; 9.4, 9.5).

These findings in terms of library of modules, “frames”, and thus, of “films” are also, in one important note, precisely due to the distributivity of the network of communications and cryptography methods, preferably on the Internet, the least-to-the-furthest “well-ordered” (usually module 8 bits or 1 byte). This is critical once it helps to assess in more competent terms the “collection permutation/combination” (STEP e, 9.5) itself, that is, for the time being of this highlighted many times repeated facet, the proper “well-ordering” process (STEPS d, e; 9.4,9.5). Consequently, the “permutation/combination” shifts now its power from the “well-ordering” isomorphic RGB/binary numbers or arithmetic (STEP d, 9.4), to the “well-ordering” isomorphic RGB/binary algorithms or processes (STEP e, 9.5). Herein is shown, therefore, the proper access from the first facet to its second facet, also many times repeated, in eternal recurrence. The “well-ordering” is common to both (STEPS d, e; 9.4, 9.5), as “permutation/combination” (STEP e, 9.5) unfolds itself form arithmetic RGB/binary arithmetic “composition”, to RGB/binary algorithms, both in symbolic and physical paths of knowledge. First-off, the production of such libraries of algorithms and processes is what is best described as the material and intellectual grounds for the Assembly programming (7, 8) according to the invention, of which the Assembly language is to be further implemented, accordingly to a new patent to follow in vicinity. Once the resources are thereof and thereon fairly illustrated and charted accordingly, in recursive and algorithmic manner, all the potential ground for higher-level programming language design, programming language according to the present invention and all other programming languages and algorithms, should be liberated in the best way possible, in accordance with both the community and the industry, governments and the people.

The problem of addressing the right implementation of the technology on the Internet, and the clarification and full statement of meaning for expressions suchlike “(typical) digital image”, or “pixel”-like and “exponential-prone basis”, as much as they seem disagreeing in essence, have, nevertheless, the same expounding theoretical ground, insofar the first invokes packaged data, or datagrams, according to Internet protocols, and the two other, although much more radical in essence, invoke the packaged quanta of information. At the most profound level however, both breach into factual information, as in measurement and statistics, used as a basis for discrete calculations. Because the technology, as pointed out, is to be set on a network of communications, preferably on the Internet, any other way, contrary to this setup, would vitiate the right implementation and the most plentiful use of the technology. In this case, at least in a first stage, it is more the CA which has to accommodate to the Internet, than the other way around.

It is neither intended to cause any deprecation of standard communications protocols. Yet, ahead in the future, and in connection with the Assembly language in accordance with the present invention, if necessary, it shall be proposed an all alone standardized protocol of communication of the technology with the communication network architecture on the Internet. For all these reasons, all that is pertinent for now is to, in overview, establish some notes on the mutual adaptation. The first goal is to accommodate without much configuration overhead and with the minimal fuss, in the most flexible manner. In such way, it has to be said that it ought to be adapted to the Open Systems Interconnection (OSI) seven-layer architectural model for communication protocols, typical package and exchange modes, and common link level hardware protocols. It suits, as expected, the typical addressing information, control information, and payload data, following all the different steps: physical, data link, network, transport, session, presentation, and application. TCP/IP (IPv6), the fundamental protocols in the suite, at the transport and internet layers, are, therefore, the essential end-to-end data communication protocols in dialogue with UTM(s) (5) in the system.

The UTMS(s) (5) in the present invention are, thus, meant to be camera/image processing CA server/data center hosting facility able to firsthand, request, and also answer to various clients in whichever type and number of servers. Depending on the informatic means and standards, it is possible to design a network of communications in many different types, from infrared light signals, to satellite links. When we refer the system according to the invention and the CA in the network of communications, preferably on the Internet, is only to show that the system, although being feasible, is not intended to be implemented in a closed network linked to one only group of private servers/data centers, but to accommodate to the all network of communications, on the Internet.

In what regards the statement of meaning for expressions suchlike “(typical) digital image”, “pixel”-like and “exponential-prone basis”, they are all subsumed under the need of requisite for eventual forthcoming application of U-Mentalism to any electromagnetic modelling computation, or computational electromagnetics (CEM), in what regards any Maxwell's derived application under boundary conditions. This is important for the reason that, however destitute of the “pixel” in one such case, for the system of the invention to be imposed, there must be a “pixel” or “cell”-like reductionist element that is, simultaneously, proficient in numerical techniques, in arranging/rearranging (composition and permutation/combination) the equivalent to RGB/binary wave-form elements, into quanta package “cells”, into the final “(typical) digital image”, with equivalent exponential-proneness, as it happens with the 3 “octet”-3 “byte” “pixel”, yet amenable and reviewable to be accommodated to any other suitable quantities, either on the basis or on the exponent in suitable quanta packages.

In the preferred embodiments according to the present invention, each UTM should be comprised mainly by a controlled (energy capacitating and light photometry beaming, focusing and obturating mechanism, distortion and aberrations lensing, etc.) image sensor (CCCD/CMOS in the actual state of the art), that is, a light-detector microprocessor super-computer, connected with a powerful integrated circuit in dialog with a clustered server/data center connected to the network of communications, on the Internet.

In the preferred embodiments, UTM(s) (5) are “frame” and “films” movement-images computing accelerators, similar to the way a physics particle accelerator works. Indeed, “(typical) digital images” (3) therein contained in well-defined light beams, with equivalently charged RGB/binary active “pixels”, are propelled to great speed by the use of electromagnetic-based computation, resulting into super-computation as a feedback effect in the cybernetic system. The comparison is also fruitful in the sense that physics particle accelerators produce scientific knowledge, to which aim the present invention is also dedicated, most especially under a related programming language to be developed ahead in the future. Also, the two models are similar in the sense that the electrostatic class of accelerators have the cathode ray tube screen as the fittest representation, as exemplified by von Neumann of what would be, at his time, an application of the “iconoscope memory”.

Obviously, there were not and still there is not any CA built from that inception, neither there is any in the industry as it is herein suggested, this time and originally with the “pixel”-dense “(typical) digital image”, little less in accordance with a cybernetic system in the network of communications, on the Internet. Some other attributes and themes, for that matter, are common to both particle physics accelerators and UTM(s): a linear direct-voltage accelerator, injection and extraction of “(typical) digital images”, storage, co-moving coordinate system, one-dimensional to n-dimensional case matching optics, matrices and periodicity conditions, etc.

In this theoretical panoply, there is even a similitude with the so-called wave-particle duality, with “pixels” herein representing the artificial informatic wave-packet quantum particle of the waveform electromagnetic flow, one such complementarity principle to be applied as a vessel for a basis and correspondent exponent in a “(typical) digital image” (3).

The invention is a general-purpose CA, and the applicability of the invention is, thus, to any area of knowledge. We shall, then, describe each Step of the Block Diagram (9) accordingly, before stating clearer an application method. The “conversion of (typical) digital images” (STEP a, 9.1) (CO) is a necessary pre-requirement processing method for each and every “(typical) digital image”, either from “general image sensing” or “general image processing”. Meticulously, a few hard-encroaching aspects shall be discerned in relation to both (1) “Internet/data: image/text ‘pixel’-composed images or general image sensing”, and (2) “AI & Cryptographic data: image/text ‘pixel’-permuted/combined images or general image processing”. Determinant aspects related to this are dependent on the arrogate Internet protocols, and on the choice of synchronous read-in of all of the “pixels” in the “(typical) digital images” (3). Because datagrams are suitable to cryptography, both their arrival to UTM(s) and their nonsynchronous read-in can contribute to a proficient cryptography. Nevertheless, that is not the preferred method of choice, both because it does not institute the most optimized and fastest “(typical) digital image” (3) read-in, which is synchronous in orthogonality, but also because TCP/IP arrival in each UTM would have to be diverged.

For the appointed reasons, a different thresh out is more fitting, and that is the case of each UTM being able to, upon the arrival of the pool (6) to Turing-machine “tape” data (4), right at the moment of “conversion of (typical) digital images” (STEP a, 9.1) or suitably synchronized with the “impression memory of (typical) digital images” (STEP b, 9.2), in the first case an “M to UTM or UTM protocol” (STEP a, 9.1), and in the last case an “UTM to M and UTM protocol” (STEP b, 9.2), cryptography being acted upon the image. This is the same as saying that, independently of a “conversion of a (typical) digital image” (STEP a, 9.1) in itself being amenable to be executed beforehand (M to UTM protocol), rather than forwardly executed (UTM protocol), it is of fundamental underlying importance to take meaning of the circumstance under which the same occurs with cryptography methods. Either cryptography can be resolved in sync with “conversion of (typical) digital images” (STEP a, 9.1), or alternatively with “impression memory of (typical) digital images” (STEP b, 9.2), that is, in the first case either an “M to UTM or UTM protocol” (STEP a, 9.1), or conjointly and exclusively an “UTM to M and UTM protocol” (STEP a, 9.1). In either these cases, it is shown in the “Block diagram” (9) the formal separation of these two first steps, as well as of the proceeding abstract demarcation to the “processing of numerical data/metadata of (typical) digital images” (STEP c, 9.3).

The relation of the system with the network of communications, on the Internet, and the world wide web (WWW), will dictate such outline, from which place the inventor has no control. A black-box mechanism is thoroughly needed to presume diagonalized cryptography methods ahead of the “processing of numerical data/metadata of (typical) digital images” (STEP c, 9.3), reason why “general image sensing” (1) and “general image processing” (2) “(typical) digital images” (3) can even be simultaneous, without anyone, except the machine if it was not a machine, knowing, not only which image is cryptography of which, but neither what image is, at all, being processed.

At this stage, the abstract process of “processing of numerical data/metadata of (typical) digital images” (STEP c, 9.3), which is the abstract correlative and complementary to the “impression memory” (STEP b, 9.2) is executed only as an “UTM to UTM protocol” (STEP c, 9.3). All of the previous actions are presumed to be handled by integrated circuits operations in communication with light detecting chips in the camera/image processing devices (CCD/CMOS technology) in the UTM(s) (5). Once the isomorphic information is now seized, into the form of RGB/binary modules, “frames”, and “films”, it follows the “well-ordering recollection of (typical) digital images” (STEP d, 9.4), which suits the connection of nodes/servers UTM(s) with data centers, in an “UTM to UTM protocol” (STEP d, 9.4). The same is true in relation with the “collection permutation/combination of (typical) digital images”, also an “UTM to UTM protocol” (STEP e, 9.5). Anyway, what is posit in this passage is the need of any of the latter processes (STEPS d, e; 9.4, 9.5) to be controlled by UTM(s), because, in essence, Internet memory can help, in data/metadata form, to store modules, “frames”, and “films”, but at stake here are the processes themselves of “well-ordering” (STEPS d, e; 9.4, 9.5), “recollection” (STEP d, 9.4) and “collection” (STEP e, 9.5). These shall be, in the preferred embodiments, indeed, an “UTM to UTM protocol” only (STEPS d, e; 9.4, 9.5). At this point, it copes with more and more “well-ordering” (STEPS d, e; 9.4, 9.5) of modules, “frames” and “films”, either from “recollection” (STEP d, 9.4) or “collection” (STEP e, 9.5), including “permutation/combination” (STEP e, 9.5) hereof presumed with the Assembly Programming (7) according to the present invention, working thoroughly resorting to full programming ability from the “well-orderings” (STEPS d, e; 9.4, 9.5). Subsequent to this, with the very same results of “well-ordering” (STEPS d, e; 9.4, 9.5), and accomplished “permutation/combination” (STEP e, 9.5), the action diagram of the CA and algorithms therein processed are ready to be, again and in loop (LO), overriding fashion or eternal recurrence, submitted to the UTM(s) into “reimpression memory of (typical) digital images” (STEP f, 9.6), so to generate more and more complexified “well-ordering” (STEPS d, e; 9.4, 9.5), i.e., “composition” (STEP d, 9.4) and “permutation/combination” (STEP e, 9.5).

It is this overall, truly long-term, both “intensional” and “extensional” last stage and repeating process, what is conjectured as the “programming processing of algorithms into (typical) digital images” (STEP g, 9.7), clearly an “UTM to UTM protocol”. It resides here the block diagram (9) rather said exitus, than terminus. And because of this sort of feedback loop mechanism (LO), we could call this stage an “algorithmitron”, i.e., an accelerating mechanism of all classes of algorithms, and thus a procedure mechanism on its own.

A practical example can be eloquent in describing the CA method. We choose such example to be automated vehicles (AV). There are two possible technical story lines approaching the problem. Either “(typical) digital images” are proper object-images of the computable surroundings and, at the same time, also computed by super-computation according to the invention with typical “well-orderings” (STEPS d, e; 9.4, 9.5) and “permutation/combination” (STEP e, 9.5), although with different “(typical) digital images” (3) than the object-images, or they are only automated by algorithms according to the invention, although maintaining a closed sensing system, thus with (sensory information) images produced on their own.

In the first outline, the repertory of “(typical) digital images” sensed by the cameras, although included in the overall system of the invention, thus “well-ordered” and “permuted/combined” (STEPS d, e; 9.4, 9.5) although extremely unlikely processed to the aim of the AV and little less in its task, are, nevertheless, taken as structural well-ordering of the surroundings in a program run by U-Mentalism (the object of the program, and the program). The result is, naturally, a robotics autonomous system, with environment open interaction and navigation, that is, under which the object-images represent the direct object of their environment in accelerating coherence, in much higher speed computed and navigated. Because the present invention is cybernetic open, therefore connected to the network of communications, on the Internet, with constant positive feedback mechanisms, the appraisal of this first hypothesis is much more worthy and valuable.

Yet, it has to be clear-cut manifest that the environment navigation is improved exponentially, not so much because of inherently accelerated processed images in the AV sensory information, nor because of the unfold higher resolution of images, but essentially because of the “well-orderings” (STEPS d, e; 9.4, 9.5), “composition” (STEP d, 9.4) and “permutation/combination” (STEP e, 9.5) of the algorithms into modules, “frames” and “films”, which are alien to the object-images, and that can really shift actual and beyond applications of digital image processing (such as classification, feature extraction, multi-scale signal analysis, patter recognition, and projection).

On the second hypothesis, in a not so much advised self-contained system, i. e., wherein the sensory information is separated from the system according to the invention, but, on the contrary, the processing unit resorts to algorithms according to the invention (STEPS a-g, 9.1-9.7) (which is an academic hypothesis reference only), the processing images are still computed at exponentially higher speeds, but without a proper feedback mechanism concurrent to the proper object-images of the environment in which the AV is performing automation. In this case, the sensory information images are never turned into the U-Mentalism system. It could be said to be a “take all, give none” approach, but truth is that it is not, once the sensory information digital images of the AV, being alien to the input of “(typical) digital images” (3) into the system according to the invention, would not beneficiate the efficacy of the system and its resourcefulness of “programmed processing algorithms” (STEP g, 9.7) in the overall and in the long run.

This last more negative example has the virtue to explain, in opposition, not only the trustingly cybernetic open intricate positive feedback mechanism, which should make use of object-images as direct input for interpreting the navigation environment, while using the very same images, at great speed, as “well-ordering”, “composition” and “permutation/combination” (STEPS d, e; 9.4, 9.5) to build the algorithms in the network. One such preferred approach is suitably described as “take all, whatever is given”. The same is saying that the input object-images “films” of the navigation environment are helping to process, in the network of communications, on the Internet, the simultaneous super-computation of many other orders of automata, connected to the network of communications, on the Internet.

This helps to elucidate why “(typical) digital image” “recollection” (STEP d, 9.4) beforehand, is strikingly important, which underlies the need to hold multiplication of many sensor cameras, and consequently as many as possible technical viewpoints and, thus, different “(typical) digital images” (3) to feed-in the system. As higher the number of “frames” and “films” at disposal run either by “general image sensing” (1) or “general image processing” (2), the higher is the hypothesis of having more complexified algorithms “Printer-to-Scanner” or “Brain-to-Eye”, and beyond the Assembly and programming language according to the invention higher “programming processing of algorithms” (STEP g, 9.7) to achieve the higher possible sophisticated performance in any general-purpose computation, or for the case being any AV in any environment at any specific task.

Therefrom, each one of the block diagram steps in the computer architecture according to the present invention, illustrated in 9, is a suitable “synthesis” of the overall process of the CA. Also, each and every step of the block diagram is irreplaceable in both its place and order, without any possible alternative step at any place in the order. The only ones concepts that show a slim shade of flexibility in relation to their order—which are the “conversion of (typical) digital images” (STEP a, 9.1) and the cryptography on the “conversion of (typical) digital images” (STEP a, 9.1) into the impression memory of (typical) digital image thereafter—are, nevertheless, necessarily subsumed and in unavoidable manner under the first (STEP a, 9.1) primarily, for reason of necessary technical conversion (CO) and privacy inherent to the multitude flow of digital images, also saving memory/processing power for further free memory/processing power of the very same “conversion of (typical) digital images” (STEP a, 9.1) products. Despite this fact, it should be called attention to the fact that, specially the method of “collection permutation/combination of (typical) digital images” (STEP e, 9.5) is enrolled based on (digital) image generation or general image processing, which might also be availed by cryptographic methods, amongst other methods, like machine learning. All in all, even the well-ordered “frames” and “films”, both in the “well-ordering recollection” (STEP d, 9.4), and in the “well-ordering collection” (STEP e, 9.5), and beyond, also in the “permutation/combination” (STEP e, 9.5) of the latter into algorithms of Assembly Programming (7) of the present invention, and even further, algorithms to be implemented in the programming language according to the present invention, are to be properly cryptographed all the way, hence shielded by machine-machine communication.

The invention is said to be an inversion of the typical von Neumann CA in the sense that the von Neumann CA is known to be a result of several well-established principles, all of which are, in turn, anchored in digital, binary, electronic, and multifunctional underpinnings of the actual state of the art computation. The U-Mentalism system (STEPS a-g, 9) in UTM(s) (5) built-in is, however, very different. It is, fundamentally, said to be an inversion of the von Neumann CA for, be that as it may, there isn't any central processing unit, but instead a network of synchronous processing units. Moreover, all the elements of the synchronous processing units are much more closely embedded in the UTM(s) network nodes, in the sense that the control unit, the arithmetic/logic unit, and the memory unit, are indiscernible. Memory is allocated to “conversion of (typical) digital images” (STEP a, 9.1) (CO) in the network of communications, on the Internet, being thus free to store not exactly the “well-ordering recollection of (typical) digital images” (STEP d, 9.4), but instead only its metadata. In like manner, even though it is a different case with the “collection permutation/combination of (typical) digital images” (STEP e, 9.5), due to the fact that these are “(typical) digital images” (3) that are not on the Internet, neither extant, and have to be generated, they too shall be, in metadata or data form, settled on the network of communications, on the Internet, as soon as the “well-ordering collection” (STEP e, 9.5) is being completed. Memory is, essentially, allocated to the body of the Internet and therefore, a void free potential resourcefulness, able to be tasked in sharp proximity with both the control unit and the arithmetic/logic unit. Very importantly, each UTM (5), although comprising a control unit, not only the instruction registers and instruction counters therein present are synchronous to others UTM(s) (5) in the network, but also, more decisively, the symbolical system on which the control and logical units perform, are not solely and exclusively binary, with consequent arithmetic integer operands and results. They are, instead, based on the “synthesis” of the “(typical) digital image” (3) and its minimal unit, the “pixel”, which comprises the “octet-byte” (alternatively, the 3 “octet”-3 “byte”), wherein the coeval RGB/binary form is prevalent, inasmuch as the graphic and central processing units in the hardware. A constant reminder in this respect, is that the U-Mentalism system of the present invention is to work with any “pixel”-like or “cell”-like form of the electromagnetic spectrum, as for instance, any package of photons in any waveform, or any quantum of information in “cell”-like (or package) in any electromagnetic wave, such that it accommodates into a direct impression a “(typical) digital image” (3).

In what regards the stored-program concept, also the system of the present invention is different in comparison to the von Neumann CA, once the UTM(s) (5) run a constant improvement or machine learning algorithm, not only the necessary “well-ordering recollection” (STEP d, 9.4), but also, more importantly, the ever-improving sufficient “well-ordering collection” (STEP e, 9.5), in such way that they both feedback onto the entire network system, on the Internet, and it permits conjointly expanding processing and memory powers, in truly man-machine and machine-machine cybernetic symbiosis.

All the different stored-programs processed in Turing-machines or UTM(s) plus the stored-programs eventually to result from the necessary “well-ordering recollection” (STEP d, 9.4), and the ever-improving sufficient “well-ordering collection” (STEP e, 9.5) algorithms resolved into Assembly design according to the present invention, are thus the proper output of the system of the present invention. In terms of input, it is illustrative the data image/text (apart from digital signal audio) “pixel”-composition and “pixel”-permutation/combination, either through general image sensing and general image processing, inasmuch as the pool.

In the context of the present invention, the pool comprises every frame of photo images, URL(s) and web pages, e-mails, instant messaging, mobile & tablet frames, digital TV, films, outdoors & consoles, virtual machines & the deep web, kernel BIOS & system logs, ATMs and GPS, etc, such that it comprises any text/image, notably RGB/binary, digital image output.

It is important to attest that the network of Turing-machines in the network of communications, on the Internet, by reason of this architecture, does not see diminished the place of assets of personal computers, but quite the contrary, including a very reasonable chance to engage participation in super-computation as independent stations. Characteristic also of von Neumann CA is the fact that the instruction fetch and data operation share the same bus, a brief prefiguration of the so called von Neumann bottleneck, with this meaning the cache memory. U-Mentalism too is all and ready-inclusive of memory and instructions, but both because the processing power is exponentially bigger on the basis of the “octet”-“byte”, even in comparison with proportional consumption, data access, and massive parallel stored-programs, and essentially because the system diverges into a network of shared buses and metadata, the typical constrictions of von Neumann CA with the state of the art technology and programming languages design, are, with the present invention, improved to higher lower-bound limits, essentially postponing the problem of programming languages design and algorithms, even though the present invention shares the backbone structure of blocks with the von Neumann CA. On such improvement is performed to higher symbolic computational complexity classes differential inner-limits, by means of accumulating more and more tractable functions. Furthermore, the Assembly of the present invention in unity with a programming language arising therefrom, are to constitute a fixed program of the system, although resulting from typical self-modifying code of the stored-program concept. In other words, the design of an Assembly language according to the present invention, resulting both from the necessary “well-ordering recollection” (STEP d, 9.4), but also, more importantly, the ever-improving eternal recurrent sufficient “well-ordering collection” (STEP e, 9.5) premises, is, thus, a sort of reprogrammable design that permits the programming itself. Because Assembly according to the present invention is to be based on diverged pipelining and caching massive parallel super-computation (MA), and treats in undifferentiated manner instructions and data in one cybernetic system, it not only permits the coadunation of assemblers/compilers, linkers/loaders into one Assembly language, as it also leverages high-level languages to new designs with very low bound runtime, compared with the available processing power. Conclusively, the ability to generate programs from programs, with the present invention, by cause of the necessary “well-ordering recollection” (STEP d, 9.4), but also, more importantly, the ever-improving sufficient “well-ordering collection” (STEP e, 9.5) premises, is made closer to scientific patterns side by side with the code, which, albeit all its astonishing merits, does not happen in the von Neumann CA. Summarizing, it can be said that present invention does not quite entail the same aforementioned digital, binary, electronic, and multifunctional underpinnings of the actual state of the art computation. Because it processes in continuous manner without predicted limited intervals into different frames per second (FPS) “(typical) digital image” (3), or “synthesis” of “frames”, it is not just digital, but analog/digital. It is not binary but instead RGB/binary. Alike, because of the continuous processing of different (FPS) “(typical) digital images” (3) without predicted limited intervals, and the fact that in its “pixel”-like or “cell-like” form, foreseeable coherent with quantum information packages, it is not electronic, but instead electronic/electromagnetic. Finally, because of the role of Assembly according to the present invention comprising of the necessary “well-ordering recollection” (STEP d, 9.4), but also, more importantly, the ever-improving sufficient “well-ordering collection” (STEP e, 9.5) premises, which permit a single program of univocal code and library of large numbers and complexified algorithms, it is not just multifunctional, but instead unifunctional/multifunctional. The Assembly according to the present invention is only connected with the “well-ordering” of RGB/binary large numbers, from both the “recollection of (typical) digital images” (STEP d, 9.4) and “collection of (typical) digital images” (STEP e, 9.5) in what regards strictly well-ordering of different (FPS) “frames”, as in an arithmetic/colour system. But it is very important to notice that the “collection of (typical) digital images” (STEP e, 9.5) allows not only the “well-ordering”, but also the “composition/permutation” (STEP e, 9.5) of these very same (FPS) “frames”. In such way, it is in the shifting gear of the “collection of (typical) digital images”, besides bare “well-ordering”, that, enabling therefrom the “composition/permutation” (STEP e, 9.5), the Assembly according to the invention departs from itself to build steadily itself and a programming language. Again, it is a pivotal shift in the system the “collection permutation/combination” passage from the “collection well-ordering” (STEP e, 9.5). U-Mentalism Assembly corresponds to a much higher symbolic and mathematical low-level language that allows much more numerous, diverse and powerful programming language design. Contrary to Assembly language, the programming language according to the invention is meant to be free-participated, open-source, collaborative, and scientifically driven.

The invention comprises a new physical symbol system (PSS), also called a formal system, again preferably working in partial U-machines, simultaneously (typical) digital imagetic and binary.

In the preferred embodiments, the invention is particularly suitable to a system of UTM(s) computation on every computing machine with conventional or alternative, but always by “(typical) digital image” information or by an interface output in the form of images. The system of UTM computation ought to be partial and distributed, over single and unitary. Henceforth, the invention comprises the embodiments of computing the workload on a single or multiple Turing-machine, or on a single UTM, but is fundamentally targeted to full implementation on as many as possible interconnected network communication on the Internet U-machines nodes over Turing-machines. Not to forget to this point that UTM(s) are also Turing-machines.

In the preferred embodiments of the present invention, the Turing-machine is a computing machine that has a processor and/or a text/image output mechanism or device.

In the preferred embodiments of the present invention, the Turing-machine is selected from a group comprising of personal computers, desktop devices, mobile devices, Internet servers, clusters, warehouse-scale mainframe computers, embedded computing machines, GPU game consoles, cloud computing, digital tv boxes, outdoors, drones, CCTV, ATM's, GPS.

The present invention imposes a massive parallel “(typical) digital image” CA, settled on many nodes camera/image processing UTM(s) over computing machine(s), with many “films” made of many modules and “frames” or “synthesis” of (digital) images. The consequences are a dramatic and truly exponential, not merely incremental, improvement in threading and computing capacity. Although “(typical) digital images” (3) can be generated through machine learning techniques, the feed-in stacks should result, in large majority, from extant (digital) images, comprehensively achieving a great gain and savings in many types of memory. All in all, it is also made possible to build a steady approximation to the evaluation of the P vs. NP problem in computation, and help to assess and measure computational complexity classes, by means of the exponential factor improvement in processing performance. More information about the P vs. NP problem is presented in Cook, Stephen. The complexity of theorem proving procedures. Proceedings of the Third Annual ACM Symposium on Theory of Computing. (1971) pp. 151-158.

The relation of the P vs. NP Problem is very similar with the relation of the so called von Neumann bottleneck with the present invention. Although by different reasons, the technicality of the invention affects both problems, and state of the art materials and technology. The CA of the present invention, far from being a solution, is nevertheless a candidate for the best interim technological approach in the eyes of the proponent, for it constitutes a leverage of optimal tractable and decidable capability of Turing-machines in a network of communications, preferably on the Internet, insofar it can postulate and clarify higher lower bounds of computational classes inner and outer limits and relations, as it can also widen the symbolic-machine route for the von Neumann bottleneck in Turing-machines.

Although having each UTM at each node or camera/image-processor resolving binary and discrete symbols, by having different modules and “frames” in successive and parallel “films” at great speed, renders the CA and the instruction set architecture also to be imagetic and continuous.

In other embodiments, the invention abridges the positive use of the Internet and World Wide Web (WWW) structures, although, as stated beforehand, the practicality of the whole implementation in bare theoretical definition, suffices with any suchlike designed Turing-machine. What is herein meant is that the referred camera/image-processors nodes as UTM(s) are to be understood as proper Internet nodes/servers. Moreover, it permits the permutation and combination of the bulk of data in a network of networks by direct processing performance, essentially through the use of as many as possible distributed partial U-machines on the Internet.

In the preferred embodiments according to the preferred invention, every UTM is a camera/image-processor able to compute digital image information or any “(typical) digital image” interface.

Therefore, what is relevant, in this scenario, is the structural and functional use of direct processing of a continuum of images, or as it may be imagetic configurations in physical and informational sense impressions, either in a typical M, or preferably in single or distributed partial U-machines over a network of Turing-machines. In such fashion, it is clearly demarcated the difference of the technology with von Neumann's “iconoscope memory”, which is reported in von Neumann, John. First Draft of a Report on EDVAC, Moore School of Electrical Engineering, University of Pennsylvania, Jun. 30, 1945, p. 32. There are mainly two reasons herein appointed. As for the first case, the invention presented settles the representation of the minimal symbolic unit in both the “pixel” and the digital image (or “frame”), which directly contrasts with the “iconoscope memory”, by far much less efficient. In contrast, the present invention is much faster, powerful and efficient in terms of processing information capacity, as it will be shown with numbers. Also to consider is the lack of coverage and technological range of von Neumann's “iconoscope memory”, which is based on the pre-LCD cathode ray tube, whereas this new CA reaches the furthest possible extent, comprising photonics, plasmonics, and even computer-brain interfaces by way of the aforementioned underlying structural and functional use.

In this regard, however the use of the term “(typical) digital image” (3) is of any computerized image of signals and data (1-2), including its branching in pure photonics, plasmonics, or even computer-brain (bidirectional) or neuromodulation (unidirectional) interfaces, and insofar they are all bore into electromagnetic waves frequencies, there is a key exponential-basis factor in the “pixel” in the digital image (3) that cannot be neglected. In truth, the digital image composed of “pixels” (3) is perfectly suited for an exponential growth of computation power, much more so if implemented in many U-machines acting as nodes/servers in a network of many Turing-machines (3-5). Actually, the “pixel” in the “synthesis” of the digital image (3) proves to be, in effective physical and symbolic terms under any CA, most specially if over on such digital sphere as the standing for the time being, the best possible, suitable, and beyond integrated, intermediation to the binary code. With this we mean that the operational physical and symbolic balance in the “pixel” (3) far exceeds the power of the presumed bare computational escalation to photonics and plasmonics.

While the operational physical and symbolic balance in the “pixel” far exceeds the power of the presumed bare computational escalation to photonics and plasmonics, precisely due to the appointed exponential-basis key factor in the “pixel” in the digital image (3), the CA here presented will necessarily expand to a different balance when the (typical) digital image (3) will be one such as composed of directly computable differences and repetitions of quantized discrete electromagnetic wave-like impressions. However, the symbolic need to joinder numerical values to symbols (as colours or wavelengths), into a minimalist symbol system as the binary, is fairly exemplified in the computable digital image, by means of the “pixel” and the digital image-to-binary passage presumed hereof (1-3, 2-3).

This proves, without margin for any doubt, that in the settled symbolic communication between the binary code and the isomorphic (RGB) model of the “pixel” (3), being the latter computed as an overall image sensor that detects and conveys information, thus converting the variable attenuation and increments in light waves directly to binary code, is where is bestowed the structural and functional engineering process newly presented in one such CA, in this way with prompt applicability. Needless to say, one such CA as herein shown is totally new, and greatly demonstrates technical and human-activity oriented usefulness.

For the time being and realistically for a short-time implementation, the “pixel” in the digital image (3), the latter being considered as the “synthesis” of the image, are hence the expectable, short-term executable and thereof reasonable implementations of the subject-matter, i.e., the process, machine, manufacture and composition of matter.

In some embodiments according to the invention, underlying the future use of direct electromagnetic waves as first imagetic impressions of the CA, must be included the inescapable use of one such reductionist “cell”-like element as the “pixel” in the “synthesis” of the image or “frame” pronto deployable, once its reductionist “cell”-like structure holds an exponential key-factor that articulates exemplary with the minimalist binary code numerical system. This is the reason why the forthwith fully deployable solution of the CA with the “pixel” and the “synthesis” of the digital image, is, as a structural element, especially cogent and fitted still to any future wave-like direct impressions as the “(typical) digital image” (3) in the CA.

Concerning the Turing-machines comprised in the CA of the present invention, most preferably in the desirable model of several U-machines image processing Internet nodes, all types of Turing-machines and M are included, as may be personal computers, desktop and mobile devices, servers, clusters and warehouse-scale mainframe computers, embedded computing machines and GPU's game consoles, TV boxes, cloud computing, or more generally, any computing machine that has a processor and/or a text/image output device. The computing machines that comprise a processor and/or a text/image output device also include the digital television, insofar as all sorts of devices for processing audiovisual signals using digital encoding, tractable to be run, as it is preferable, by U-machines on the Internet.

Also to be considered in relation with the embodiments is the comprehensiveness of the system as a whole so to be inclusive of all classes of parallelism in von Neumann or non-von Neumann CA (most generally general-purpose, operand or memory register CA), as long as they make allowance for the symbolic binary code system beforehand, or indeed any numerical or therefrom coherent system, such as HEXA and RGB (6-4; 1-3, 2-3). The same is true in relation to all the possible ways for any hardware to support data-level or task-level parallelism (5).

Most naturally, it follows from here that all classes of ISA in M(s) (4) or UTM(s) (5), independently of their class (register-memory or load-store), memory addressing, type and size of the operands, full operations, control flow instructions, fixed length or variable length encoding, as for all the many other challenges and practicalities involved in any CA design, ought to be computable in the technology, most preferably in a network of distributed and partial UTM(s) nodes/servers camera/image-processors over many M(s) on the Internet (3-5).

Regarding an eased application of the present invention, it is referred herein direct image processing in “films” by UTM(s) or M(s). Typically, in this setup, direct images of the tractable object of study are processed, thus offering an exponential gain of partial computable functions over every possible domain of study. Its scientific and technical applicability can be demonstrated, for example, in satellite image processing, aerodynamics, hydrodynamics, thermal and fluid objects, with strong impact in various areas in a new level cybernetics.

Regarding another preferred application of the present invention, it is referred herein computing the proper inherent binary sequences, already disposable as “pixel” colors, disposed in the various “synthesis” of the image in RGB/binary “films”, all run in sequence and in massive parallel computation (MA) by instruction, accelerating computation. This application can be done either through the reception of digital images to be computed, or by the input of the proper equivalent isomorphic binary code settled in the digital image. Under this level of UTM(s)/computing machine(s) processing, there is also the possibility of opening a field for a new Assembly Programing language design and programming language paradigm.

One remarkable advantage of the invention is related to the excessive computing resources it welcomes. Concerning freed up processing power and access memory, and in order to respect the freedom of speech and democratic laws, civil and political rights, and to the highest possible extent, the abidance by the information privacy law in different jurisdictions, in the present invention, tools of cryptography ought to be used on the whole set of digital images, as “synthesis” of the different images processed, in either M, or preferably in each and every partial and distributed UTM node, in the network of communications, on or outside of the Internet. In the preferred embodiments, the present invention shall employ the blockchain technology, as well as all conveyable most secure and up-to-date internet and communications cryptography protocols to this end. Only doing so, the present invention may contribute to the design of a free and responsible Internet, and not jeopardize the technology good endeavor.

The present invention is perfectly coherent with the standard von Neumann CA, it is isomorphic with the binary code symbolic system, all the programming languages, and Internet protocols. Its paradigm-shifting new practicality can entirely accommodate to any standard or new physicality and functionality of the network of communications, conciliated with massive parallel super-computation, also converging to any standard or any new design of programming languages and Internet protocols. The “stored-program” concept is, by result of the well-ordered libraries of “frames”, and “films” as n-dimensional moduli spaces, a processing performance of exponential factor on “pixel”-like basis.

The direct use of algebraized and functional programming relations on either recollections (7.1-8.1) or collections (7.2-8.2) (including cryptographed, machine learning and AI image processed, or any programming methods applied) of (typical) digital-images FPS “frames” or “films” (3), should also, in accordance with U-Mentalism Assembly (7), constitute a decisive improvement-factor on top of super-computation itself.

The CA and instruction set architecture of the present invention are applicable to any set of computerized images of signals and data, including actual and close approaching new applications in photonics, plasmonics, computer-brain interfaces, or neuromodulation, as it is with any Turing-computable alternative system, such as quantum computing.

The CA workload, in the preferred embodiments, is operated through each camera/image-processor UTM node in time synchronicity, symbolic isomorphism, and physical orthogonality. In this standpoint, inside the minimal unit of the “pixel” there is to consider the specific isomorphy between the “byte” and the “octet”, and consequently the 3 “octet”-3 “byte” per pixel at each Frame per second (FPS) computed. Therefore, the digital image is read in synchronicity and orthogonality at each “pixel density” converted frame-per-second (FPS) “frame” or image “synthesis”.

The read-in of such “synthesis” of “frames”, is therefore elaborated into bigger “synthesis” of “films” or “movement-images” that are to be read and processed at each camera/image-processor node in the network of communications, preferably on the Internet.

This camera/image-processor nodes are Universal Turing-machines and the network of communications, preferably on the Internet, is firstly of prior art, made of Turing-machines working within classical computation, although later to be more and more composed of Universal Turing-machines, furthermore with a new Assembly language adapted to super-computation in a network of communications, named U-Mentalism Assembly, again preferably being executed on the Internet.

In the preferred embodiments of the invention, it is the “octet”-“byte” isomorphic relation what enables Turing-machines in the “system” to communicate with the UTM(s) over the network of communications, on the Internet. Whatever is the change of units of reference in the “system”, a similarly like well-balanced and ordered bridge between “(typical) digital image” (3) or wave-like form and numerical symbolic system must ensue. In the context of the “pixel”, the “octet”-“byte” inter-relation is said, more accurately, to be 3 “octet”-3 “byte” per “pixel” at each FPS.

### (Typical) Digital Image

Whenever we say “image information” or “digital image interface” is one such as composed by (overwhelmingly RGB, but also Black & White) image/text (1-2). In the context of the contemporary state of the art, the digital image composed of (RGB) “pixels” (3) is the norm, but the invention's breadth anticipates, as stated before, the use of any of further Maxwell's equations derivative use for a minimal symbolic unit (such as the photon, or the wavelength and frequencies in the electromagnetic spectrum) in substitution of the “pixel” (3), and thereof a fixed set of photonic or even plasmonic quantized configurations, in substitution of the “synthesis” of the image, or “frame” (3).

In one embodiment according to the invention, the “synthesis” of the symbolic unit is the pixel in the “(typical) digital image” (3). Preferably, for the reason of state of the art technology and landscape of the industry, inseparable from efficiency convenience, the “pixel” is herein regarded as its minimal symbolic unit, in connection with the digital image as the frame “synthesis”. Both the “pixel” and the image “synthesis”, namely their “frames”, shall be processed at the same time, in synchronicity, independently of the computing speed.

In the embodiments according to the invention, any other “synthesis” of units in reference to the “(typical) digital system” are suitable. The same is true in connection with the abridgement of all possible units of reference to any other symbolic units on the side of all possible Turing-machines working on the technology, or as it may be any U-machines over Turing-machines.

Therefore, in the preferred embodiments, the digital image includes numeric representation in one or more codes, such as the Hexadecimal system (HEXA), or even direct programming and processing via the more loosely binary, and overly imagetic Red, Green, and Blue (RGB) colour symbolic system. In the digital image (3) we are considering either the existence of any digital image, hence devoid of sound, as also numerical information found in any possible digital sound-on-film formats, as long as one such numerical information is tractable into binary code (or any other symbolic code read on the CA), thus on each UTM node/server (5) and on any possible existing Turing-machine (4) altogether working with any further and future (typical) digital-image-to-intermediate applied symbolic code.

Also conveyable in the economy of the CA is the creation of well-ordered algebra principles and algorithmic patterns based on the RGB colour system, which can create methods of calling functions of module linear “pixels”, “frames” of images, approximated to the existent flow of information (isomorphic to the binary code), either read (7.1) or programmed (7.2). To this effect, it is advisable, in the context of creation and development of U-Mentalism Assembly (7), the proper discrete optimization of several different discrete values of the RGB “pixel” model (most especially of well-ordered modules, “frames” and “films”) (7.1-8.1; 7.2-8.2), or indeed any other different-unit model created in the future to cope with the CA.

The technical subtility of the expression “(typical) digital image” (3) is overly important. With this we mean that the technology of U-Mentalism CA is, predominantly, an inversion of the standard CA in the sense that the physical symbol system, and therefore the symbolic model (SM) of the ISA or CA, has the direct image, beforehand any quantization into discrete numerical values, as its primary symbol. For the time being, one such image is, surely, what is recognized as a digital image (3) in the current state of the art, which should be processed, preferably, by as many as possible interconnected network communications on the Internet U-machines nodes/servers (5).

In a much more in-depth specification, insofar U-Mentalism CA can be run with other CA means of implementation (photonics, plasmonics, computer-brain interfaces, or neuromodulation), with U-Mentalism CA the direct image (3) is any electromagnetic-wave-like physical symbolic impression—thus beyond the limited sense of “photography”, or indeed photonics, as “graphics of photons” (plasmons or the alike), independently of the intermediate symbolic system used—and that “(typical) digital image” (3) attests for, not so much the coeval interpretation of discrete electric on/off signals represented as 0's and 1's digits of the binary system only, but instead all of the discrete differences and repetitions in any of Maxwell's possible derived wave-like impressions, hence feasible for computation as a direct symbol system in U-Mentalism CA, preferably by as many as possible interconnected network communications on the Internet U-machines nodes/servers over M(s) (3-5). In this case, the physical symbolic system might well be the proper electromagnetic waves, therein the direct (computable) “impression”. The technology, in this fashion, is primarily imagetic, either by the impression of a digital “frame” composed of “pixels”, either by the direct impression of electromagnetic waves (3). While much less relevant than electromagnetic wave-like (computable) impressions herein considered as “(typical) digital image” (3), the same is true in relation to acoustics, i.e., mechanical waves in gases, liquids, and solids (from vibrations to sounds, from infrasound to ultrasounds), as computable impressions in (typical) digital images in the CA (3).

In other embodiments according to the present invention, the “(typical) digital image” (3) of the CA or the instruction set architecture may be related to quantum computing. Therefore, the direct image may be any electromagnetic-wave-like physical symbolic impression, or equally any (typical) digital image as the primarily processed symbol in the machine. In fact, this argument is sound enough if we remember that the symbolic system of quantum computing emulates the binary code (qubits being, although, a two-state quantum-mechanical symbolic system), and also the irrevocable fact that quantum computers can be simulated by any computing machine or Turing-machine, and thereupon by any UTM.

The computer architecture and instructions set architecture according to the present invention may, preferably, ought to be executed by as many as possible interconnected network communications on the Internet U-machines nodes over computing machines, independently of the physical symbolic system, also accountable for quantum computing.

The present invention is congruent with the von Neumann CA predominance in the state of the art and industry, as it is also for any CA established on the symbolic binary system and, beyond, with proper electromagnetic waves physical and symbolic computable “impressions”, as well as with high-level abstract programming languages. As a matter of fact, one such new CA as now presented, inherently congruent and isomorphic with classical computation and the binary code symbolic system, truly liberates the expressive power of all programming languages. Moreover, it is desirable that a programming language functionality, paradigms, and shifts persist, regardless of different applications, so that their facets and expressive power are increased in dialogue and communication with the CA herein claimed.

Computer Architecture and Instructions Set Architecture Structure

In accordance with the present invention, the general-purpose high-level performance threads computed by the CA at each camera/image processing node/server composed of an Universal Turing-machine (UTM) in concurrent RGB/binary isomorphic parallelism to the binary code computation in M(s), in the network of communications, preferably on the Internet, are said to follow a method comprising the following steps, which are further detailed herein:
a. Conversion of (typical) digital images to a predetermined density of the pixel equation, or image resolution, resulting in a set of converted digital images;
b. Impression memory of image/text RGB/binary “pixel”-like isomorphic (typical) digital images allocated in numerical data or metadata, resulting in a set of allocated numerical data or metadata;
c. Processing of the image/text RGB/binary isomorphic allocated numerical data or metadata of the (typical) digital images, resulting in a set of processed digital images;
d. Well-ordering recollection of the image/text RGB/binary isomorphic processed (typical) digital images from the least-to-the-furthest well-ordered numeric representation of the digital images, resulting in a set of well-ordered digital images composition (9.4), and whenever computation prerequisites only recollection well-orderings can be reimpressed (9.6);
e. Well-ordering collection of the image/text RGB/binary isomorphic processed (typical) digital images from the least-to-the-furthest numerical and algorithmic representation, resulting in a set of well-ordered digital images collection;
f. Reimpression of the image/text RGB/binary isomorphic processed and well-ordered (typical) digital images, resulting in numerical data or metadata;
g. Programming processing of image/text RGB/binary isomorphic processed and well-ordered algorithms based in numerical data or metadata.

In the preferred embodiments of the present invention, the processing c) and g) of the digital images is executed into one or more elements of the group comprising of graphic processing units (GPUs), general-purpose central processing units (CPUs), and highly massive parallel computation systems.

In the preferred embodiments of the present invention, the density of the pixel equation in accordance with the number of pixels, in the step a) of conversion of (typical) digital images to a predetermined required image resolution conversion, results in a set of converted (typical) digital images.

Universal Turing-Machines (UTM) herein present in the invention are therefore, apart from the actual re-organization of the cybernetic structure, the most important existing in fact single new structure to be integrated thereof. Accordingly, each and every UTM structure must be deployed in one such fashion as to bear image processing (into RGB at the UTM) and central logic and control processing (into binary code at the UTM), in turn both settled into the coeval and isomorphic “pixel” contained “octet”-“byte”, alternatively, the 3 “octet”-3 “byte”, scheme as referred. Also important are the notions of orthogonality and synchronicity in each and every UTM and its memory/processing power, by which the “conversion of (typical) digital images” (STEP a, 9.1) is made exempt of errors, and set within a coherent and accurate clock rate between FPS (Frames per Second) digital images throughout the all network of communications, preferably on the Internet. For this reason, it is fair to describe it as massive parallel computation (MA), under which network of communications of UTM(s) over computing machine(s), preferably on the Internet, each UTM is part of an horizontal, non-hierarchical structure, alike the Internet.

Nevertheless, is has to be pointed out that, very much so like the Internet network system (Vannevar Bush, 1945; Joseph Licklider, 1960; Douglas Engelbart, 1968), which has hypertext media as a fluent world wide web document protocol system in horizontality (Tim Berners-Lee, 1990), although depending on an hierarchy structure of networks, necessary to the realization of many unrestricted and free applications, coequally the present invention, in what regards the UTM(s) communication, workload, protocols, and applications, dependent of the “octet”-“byte” scheme, alternatively, the 3 “octet”-3 “byte”, could be thought of as having to be built on the presumption that some UTM(s), namely the ones designed to enroll on the “collection permutation/combination of (typical) digital images” (STEP e, 9.5), and consequently the loop (LO) and eternal recurrence of “reimpression memory of (typical) digital images” (STEP f, 9.6) and “programming processing of algorithms into (typical) digital images” (STEP g, 9.7), by reason of processing image generation algorithms of the Assembly according to the present invention, are to be primordial in importance, beyond necessarily further implementation of hierarchical, or, better said, well-ordered, designed coupled Internet protocols according to the invention. But this is not the case, by reason of the package distribution of information processed in the network, which can be distributed by several UTM(s) in the network, besides cryptographic methods that mask which UTM(s) are really dedicated to the “collection permutation/combination of (typical) digital images” (STEP e, 9.5). It could not even be disclosed which UTM(s) are dedicated to “programming processing of algorithms into (typical) digital images” (STEP g, 9.7), once each UTM, besides computing equally (typical) digital images, has them distributed in the network and subject to cryptography. In accordance, as illustrated in 5, the arrows settled in distributive form between the UTM(s), are not to show any hierarchical predominant structure, but an overly decentralized horizontal parallel network instead, under which conditions every UTM node/server is equally able to fetch, decode and execute any instruction order, and wherein the UTM(s) are in a network of communications, preferably on the Internet.

In what concerns parallel and sequential serial processing in the technology, and particularly in the UTM(s) (5), some aspects should be identified. However true that the overall system and its subscribing services are to be defined in parallel, thus with simultaneous execution of processes and calculus, a key to high-performance computing, there is also a linear bounded aspect to both the CA and the algorithms it produces, that is worthwhile calling attention to. Because of the “well-ordering” of large numbers in RGB/binary form under the “(typical) digital image” in what constitutes the “recollection” and “collection” of isomorphic (typical) digital image least-to-the-furthest well-ordered modules, “frames”, and “films” (STEPS d, e, 9.4, 9.5), the “well-ordering” of the “recollection” and part of the “collection” is necessarily linear. Yet, one such linear recollection is made possible by massive parallel computation (MA) of the system. Much like, for instance, the sieve of Eratosthenes algorithm, there will be intervals of absent least-to-the-furthest “(typical) digital images” RGB/binary in the sequence of modules, “frames”, and thus of “films”, which are easy to solve, as the parallel computation in the network of communications, preferably on the Internet, will rapidly provide the very same intervals, in large numbers RGB/binary isomorphic “well-ordered” arithmetic linear fashion (STEPS d, e, 9.4, 9.5). Hence, in the very same step (STEP e, 9.5) what follows to the last action is still the “well-ordering”, but not anymore of RGB/binary large numbers isomorphic to modules, (FPS) “frames” and “films” in arithmetic linear fashion only (STEPS d, e, 9.4, 9.5), but instead and beyond the production of “well-ordered collections” also of algorithms (STEP e, 9.5), whence computed by “permutation/combination” of the latter, properly designated super-computation libraries of algorithms, ever more and more powerful and, thus, able to be processed in massive parallel computing. Whereas the “well-ordered recollection of (typical) digital images” (STEP d, 9.4) is totally machine-oriented, alike the action of the “well-ordering collection” (STEP e, 9.5) in what concerns the absent intervals of the large numbers in RGB/binary form under the “(typical) digital image” (FPS) “frames” and, thus, “films”, that is not anymore the case when it is triggered the action of “well-ordering” “permutation/combination” combined (STEP e, 9.5) of many different super-computation algorithms, which is, definitely, man-machine oriented (STEP g, 9.7). By cause of this, it is a fair statement to say that therein is where a CA and algorithms are inextricable the most, alike linear and parallel super-computation.

Not only this, but also the man-machine symbiosis is enticed, reason why the programmer and the machine ensemble are said to produce a passage of typical M(s) and UTM(s), to non-fully deterministic oracle-type M(s) and UTM(s) (hopefully approximating hardness to decidable problems, and to their ease of verifiability) in the network of communications, preferably on the Internet. Because, in truth, classical computation is, in natural science, a part of quantum computing, one such system is always better said a constriction of non-deterministic computation, even in the case of deterministic Turing-machines. This is also whereby the importance of the Assembly language according to the present invention is highlighted, as it is clear that, following the “composition” of “well-ordering recollections” (STEP d, 9.4) and the “permutation/combination” of “well-ordering collections” (STEP e, 9.5), which prefigure the total linear and arithmetic large numbers isomorphic to RGB/binary modules, (FPS) “frames”, and thus, of “films”, of “(typical) digital images” production, what ensues is the latter's “permutation/combination” of “(typical) digital images” (STEP e, 9.5) so that the programmer and the machine can dialog within a frame of reference, that is, a low-level super-computation programming language which can correspond between the RGB/binary image/text modules, (FPS) “synthesis” of “frames” and “films”, including their feasible “permutations/combinations” (STEP e, 9.5), and larger, much higher-level—indeed, so high-level that it would parallel compute a linear univocal programming language—CA machine code instructions in the network of communications, preferably on the Internet. This is why assembly code is reasonably recognized as peculiar to each CA and system, reason enough to so be it in relation to the CA and system, as just referred, in the network of communications, preferably on the Internet, to which end we have chosen to mention ahead “Assembly Programming” (7) into both “Eye-to-Brain” and “Brain-to-Eye” RGB/binary “synthesis” according to the invention.

Further aspects related to each one of the steps illustrated are presented.

Conversion of (Typical) Digital Images to a Predetermined Density of the Pixel Equation, or Image Resolution, Resulting in a Set of Converted Digital Images

This step comprises feed-in and conversion of as many as possible (typical) digital images, from many sources in the network of communications, and of many types, for example photo images in all formats, URL(s) and Web pages, e-mails and instant messaging images, mobile and tablet frames, digital TV “frame” images in “films”, outdoors and consoles “frames”, virtual machines & the deep web images, kernel, bios, and system logs images, ATM(s) and GPS, etc. The digital images can be redirected or not from special internet protocols, yet surely from Turing-machines on the network of communications, to the forward “impression of (typical) digital images” (STEP b, 9.2), either by generally image sensing or intermediate general image processing, into Universal Turing-machines camera/image processing nodes/servers.

In the preferred embodiments of the invention, apart from the “conversion of (typical) digital images” (STEP a, 9.1) possibly being an UTM only protocol, and not an M to UTM protocol i.e., the “(typical) digital images” upon their arrival being performed with completed conversion required and in no way by an UTM protocol, also, in theoretical terms, it can possibly be devisable with the technology a system whereby Internet protocols are responsible for cryptography methods. However, these are not the appointed methods in the preferred embodiments of the invention, insofar what is contemplated is, together with a feeding and conversion of (typical) digital images with ready status hopefully by an M to UTM protocol, also the concealment/cryptography of the input of digital information in modules, “frames” and “films” should be exclusively an UTM protocol on the basis of the M to UTM to M communication, and always before the “processing of numerical data/metadata of (typical) digital images” (STEP c, 9.3). This signifies that at the “impression memory of (typical) digital images” (STEP b, 9.2) in interim or in tandem should always reside the application of cryptography methods. In case not granted and, in any case really, the “conversion” can always be performed by UMT protocol only, and what is more relevant, cryptography methods can be applied by Internet protocols, in which case “combined/permuted” datagrams are preferable. Yet, most preferable of all is whereby cryptography methods are applied instead by an UTM only protocol, through which what is achieved is a pure machine-to-machine black-box mechanism upon the concealment/cryptography of “(typical) digital images”, a significant difference with the eventual Internet protocol datagram “permutation/combination”, as with the preferred method cryptography is shielded purely under an UTM protocol. Cryptography methods are, therefore, always applicable to a feed-in and read-in of “(typical) digital image” beforehand its processing.

In the preferred embodiments of the present invention, every UTM is a camera/image-processor node/server able to compute digital image information or any (typical) digital image interface.

In either way, at each Universal Turing-machine camera/image-processor node/server it is performed a read-in of (typical) digital images, or “pixel”-like exponential-prone “cell”-like “composed” images from the aforementioned sources. Loading the individual and collective threads in each Universal Turing-machine can, however, be separated into two main sources: either the simple data, original even if cryptographed, present on the network of communications and of read-in image sensing nature, thus ready to enter as an “impression” (STEP b, 9.2) at each Universal Turing-machine is read-in by the camera/image-processor sensing, or general image processing images are, in turn, read-in as a result of artificial intelligence, machine learning, or even cryptography methods of general image processing nature, thus ready to enter as an “impression memory” (STEP b, 9.2) into each Universal Turing-machine camera/image-processor node.

With the just covered process there is a flux (FL) of different “films” to the Universal Turing-machines camera/image processing nodes/servers, with each “(typical) digital image” address on the network of communications, preferably on the Internet, being stored, in opposition of for the most part the actual image being stored, therefore with great discharge of storage memory.

Nevertheless, complementary to the read-in capacity of camera/image-processor Universal Turing-machine nodes/servers, there must be allocation or storage, in the very same process, as it is below detailed, of the different blocks of either “recollected” (STEP d, 9.4) or “collected” (STEP e, 9.5) “synthesis” of modules, “frames” or “films” from the “(typical) digital images” (3) into the very same network of communications, preferably on the Internet, of Universal-Turing machines.

The step of conversion of (typical) digital images is performed whereby pixel density in accordance with the number of total pixels indicates the image resolution and, thereby, a platform for conversion of (typical) digital images on the basis of numerical methods. It is herein referred that one such conversion is best suited to an M to UTM protocol, but can also be performed by the UTM itself, hence solely an UTM protocol.

### Step of Impression Memory of Image/Text RGB/Binary “Pixel”-Like Isomorphic (Typical) Digital Images Allocated in Numerical Data or Metadata, Resulting in a Set of Allocated Numerical Data or Metadata

The step of impression memory of (typical) digital images occurs in the Universal Turing-machine camera/image-processor nodes/servers, in the network of communications, on or outside of the Internet, thus being the sensing input of (typical) digital images RGB/binary image/text isomorphic “pixel” or “pixel”-like, hence an UTM to M, and UTM protocol.

In some embodiments of the invention, both the stacks of U-Mentalism “Eye-to-Brain” RGB/binary “synthesis” of modules, “frames” and/or “films”, and the stacks of U-Mentalism “Brain-to-Eye” RGB/binary “synthesis” of modules, “frames” and/or “films”, are to be computed into the network of communications of Universal Turing-machines, i.e., as “reimpressions” (STEP f, 9.6) into the Universal Turing-machines camera/image-processor nodes/servers, as were beforehand and also by separate sources, the image/text “pixel”-composed images in “general image sensing”, and also the image/text “pixel”-permuted/combined images from “general image processing” methods in artificial intelligence or machine learning.

In the preferred embodiments, the impression of (typical) digital images Step may be carried out in the read-out camera/image processing nodes/servers, either from general image sensing data, or from general image processing. Both the “general image sensing” and the “general image processing” should be cryptographed. It is a matter of proper concealing and cryptography method whether to process thereafter the origin “(typical) digital image” data/metadata, or the cryptographic resulted image only. Because of the black box machine-to-machine mechanism, the relevant data/metadata of the original “(typical) digital image” should always be tractable in “well-ordered” terms. There is no need of RAM memory to the CA, except the Internet or network communications address of the image/text, which has a defined symbolical unit in each frame per second (FPS), having the conversion of “pixels per inch” (PPI) been resolved algorithmically in advance. Encoded in the digital image is all its pertinent information, including sound and meta-data if it is the case.

The “impression of (typical) digital images” is a read-out of the “pixel” and the “synthesis” of the (typical) digital image, modules or “frame”, with each frame per second (FPS) being stored in UTM(s) server/data centers in the network of communications, again preferably on the Internet. While so, in interim et in tandem cryptography methods are applied to the received impressed images. Preferably, each RGB/binary isomorphic (typical) digital-image, or foreseeably any direct image electromagnetic wave-like physical symbolic impression that applies to the underpinnings of the CA shall be allocated in servers/data centers, and well-ordered. The well-ordering comprises, as it is detailed in the fourth and fifth Steps, uniquely isomorphic ordered at each “pixel”, “frame”, and “film”, either from “recollections” or “collections”, to a unique ordinal/binary number.

### Step of Processing of the Image/Text RGB/Binary Isomorphic Allocated Numerical Data or Metadata of the (Typical) Digital Images, Resulting in a Set of Processed Digital Images

The step of processing of the allocated numerical data/metadata of (typical) digital images, is whereby image/text RGB/binary “pixel” or “pixel”-like isomorphic data/metadata is read-in into the UTM camera/image-processor nodes/servers, in the network of communications, on or outside of the Internet, hence an UTM to UTM protocol.

Step of Well-Ordering Recollection of the Image/Text RGB/Binary Isomorphic Processed (Typical) Digital Images from the Least-to-the-Furthest Well-Ordered Numeric Representation of the Digital Images, Resulting in a Set of Well-Ordered Digital Images Composition, and Whenever Computation Prerequisites Only Recollection Well-Orderings can be Reimpressed

The step of well-ordering recollection of (typical) digital images, is whereby data/metadata RGB/binary “pixel” or “pixel”-like isomorphic least-to-the-furthest, usually module 8 bits or 1 byte, “synthesis” of modules themselves, “frames”, and thus of films, are well-ordered, hence an UTM to UTM protocol.

The step of recollection and partial distributed storage in global memory of the system, of each and all “synthesis” of modules, “frames”, and “films”, each marked with numerical stack or abstract data type identity by well-ordered least-to-the-furthest n-dimensional module arithmetic and programming groups, results in stacks or “films” which are ready-to-use programming instructions, subroutines or functions. These stacks or “films” are ready-to-use programming instructions, subroutines or functions so to perform massive parallel super-computation (MA) isomorphic to the binary code, again processed in Universal Turing-machines on the network of communications, preferably on the Internet.

In the preferred embodiments according to the invention, after having estimated the input response of the overall linear time-invariant system by use of frames-per-second (FPS) (typical) digital images at each camera/image processing node/server, it is possible to work a recollection of determined sets of RGB/binary text/image data, which constitute much bigger computational “synthesis” isomorphic to the binary code of classical CA, besides processed at a much greater speed.

In order to obtain this gain, it is necessary to carry out well-ordering into two Steps, which comprise uniquely order isomorphic at each “pixel”, module, “frame”, and “film”, either from “recollections” or “collections”, to a unique ordinal/binary number.

The well-ordering of the cited relations, both from “recollections”, designed U-mentalism “Eye-to-Brain”, and “collections”, designed U-Mentalism “Brain-to-Eye”, both building up U-Mentalism Assembly are, thus, in the line to be, afterwards, the proper technical matter and abstract result of CA and instruction set architecture according to the present invention. Consequently, they should constitute ready low-level machine instructions and high-level threads to be loaded and executed for any fit to be solved computer science problem, with very specific directives, macros and labels that should result from the technology. It is important to refer that all classes of Turing-complete computer problems are fit to be solved with the present invention, but its invaluable core should be scientific, technological and knowledge-driven applications.

The direct use of algebraized and functional programming relations on either “recollections” or “collections”, including cryptographed, machine learning and AI image processed, or any programming methods applied of “(typical) digital images” (3) (FPS) “pixels”, modules, “frames” or “films”, should also constitute a decisive improvement-factor on top of super-computation itself.

Step of Well-Ordering Collection of the Image/Text RGB/Binary Isomorphic Processed (Typical) Digital Images from the Least-to-the-Furthest Numerical and Algorithmic Representation, Resulting in a Set of Well-Ordered Digital Images Collection

The step of collection permutation/combination of (typical) digital images, is whereby data/metadata RGB/binary “pixel” or “pixel”-like least-to-the-furthest isomorphic well-ordering comprises (usually module 8 bits or 1 byte) new “synthesis” of modules, “frames”, and “films”, by “permuted/combined” general image processing methods, cryptographic or others, hence an UTM to UTM protocol.

The step of collection and partial distributed storage in global memory of the system, is of every and many “synthesis” of modules, “frames”, and “films”, henceforth marked with an unprecedent numerical stack, subroutine or function identity by “well-ordered” least-to-the-furthest n-dimensional module arithmetic and programming groups. These stacks, due to their numerical and ordinal well-ordered nature, can also work as a foundation to general image processing methods, and also cryptography or any other mathematical method. Furthermore, it is also possible to put in place other more sophisticated mathematical and programming methods, by which the art of programming is improved. As much as U-Mentalism “scanner-to-printer”, or U-Mentalism “Eye-to-Brain”, is more attached to “composition”, i.e., to exploring the composition of relations as the relative product of the factor relations in terms of RGB/binary “pixel”-like exponential-prone “cell”-like basis, into an well-ordered set of stacks or any “synthesis” of modules, “frames and “films”, wherefrom a relative multiplication in the calculus of relations of “pixels” is enriched, U-Mentalism “printer-to-scanner”, or U-Mentalism “Brain-to-Eye”, is more attached to “permutations/combinations”, i.e., to either arranging/re-arranging or selecting of the precedent relative product of the factor relations in terms of RGB/binary “pixel”-like exponential-prone “cell”-like basis “synthesis” of modules, “frames” and “films”, into newer isomorphic “well-ordered” relations thereof. Hence, a proper “permutation/combination” programming and algorithmic craft out of “composition” of relations of “pixels” or “pixel”-like “cells” information is achieved, wherein stacks are free-“well-ordered” and distributed in the topology of the network of communications, preferably on the Internet.

In the preferred embodiments of the invention, beyond their direct computational use, it is possible to carry out the “collection” Step by even employing AI and machine learning “recollections” (2; STEP d, 9.4) from the very same AI and machine learning “recollections”, but from general image processing alien to the U-Mentalism system, (2; STEP d, 9.4) (reason enough for AI and cryptographic data to be of general image processing, “recollected” and original into the U-Mentalism system) in order to fully program and determine the output signal and code for any desired dynamic linear system RGB and also “(typical) digital image” (3) into all the variety of the CA and instruction set architecture demands.

Step of Reimpression of the Image/Text RGB/Binary Isomorphic Processed and Well-Ordered (Typical) Digital Images, Resulting in Numerical Data or Metadata

The step of reimpression memory of (typical) digital images into Universal Turing-machines, is whereby from the precedent, “recollections” and “collections” of (typical) digital images of data/metadata RGB/binary pixel-like isomorphic least-to-the-furthest comprising well-orderings (usually module 8 bits or 1 byte), are fresh and newly allocated forming the sensing input of “recollected” and “collected” “(typical) digital images” into the UTM(s), hence an UTM to UTM protocol.

Step of Programming Processing of Image/Text RGB/Binary Isomorphic Processed and Well-Ordered Algorithms Based in Numerical Data or Metadata.

The step of programming processing of algorithms into (typical) digital images, is whereby numerical-algorithmic problems are processed recurring to the stacks, subroutines or functions of both “recollected” and “collected” “synthesis” of modules, “frames”, and “films” of (typical) digital images of data/metadata RGB/binary “pixel” or “pixel”-like isomorphic least-to-the-furthest well-orderings (usually module 8 bits or 1 byte) (these “recollections” and “collections” named U-Mentalism Assembly), ahead befitted for U-Mentalism programming language in super-computation in the network of communications, on or outside of the Internet, advisably more driven to scientific knowledge.

### Computer Architecture and Instructions Set Architecture Structure Computing Power

In order to illustrate the computing power of the present invention, we shall first consider the general analogy between the “byte” and the “pixel”, with each color (RGB) “pixel” allocating 3 bytes, which gives a total of 2⁸, i.e. 256 tonal/chromatic values per byte in the “pixel”, inasmuch as the number (cardinal), and positions (ordinal) binary values (0-255). Hence, by this effect, a single (RGB) “pixel” holds, as it is known, 16.777.216 bytes and colour combination, or 2²⁴ in prime factorization. This product of prime numbers will be important in connection with information public-key cryptography technology. This is, most surely, of prior art, whilst it is not the idea of allocating this very same value—2⁸ for each color (RGB) in each byte of the “pixel”, and 2²⁴ in the “pixel”, thus also the correspondent value on the “frame” dependent on resolution—as the minimal symbolic unit of the CA, thence of computability theory proper in any U-machine or Turing-machine, by direct processing of an image to its binary form, which is alternative to every CA to this date. This also unveils the technology's most important structural and functional feature: at or near the speed of light (typical) digital image-to-binary singular and/or multiple-nodes CA.

With the foregoing is also meant that it is included in the technology and in its structural and functional method all possible variations of measures over the “pixel”, the “synthesis” of the image or the “frame”, and consequently, all the subsequent possible states or configurations. The exact same holds for the technology standards and apparatus referrals herein disposed.

A practical example of this might be the recommendation, in the era of photonics computing, to scale up under the referred technology, however having a great number of discrete packets of energy or photons according to their two main properties—frequency and wavelength—so to implement a “pixel”-like single-“cell” with exponential-basis proneness, at present settled as 2^{8.3} per “pixel” in the digital image, in this speculative setting scaled up to, as it might be, 256^{8.3} per unit in photonic computation with resolution-dependent correspondent value in the “synthesis” of the “(typical) digital image” (3), or wavelength “frame” impression in the technology. If this very same description would be under a scenario of photonic quantum computing, the very same value of 2^{8.3} would be one such equal in relation to qbits, being the alternative even having the proper appointed value of 256^{8.3} as the minimal number system unit, although always isomorphic to the classical binary code, meaning with this that all the possible bits per unit in photonic quantum computing in this figure were either in the zero state or the one state in pure photonics means, operated by a CA according to the present invention.

At this point, the “density of the pixel” equation in accordance with the “number of total pixels” image resolution becomes the norm of the present invention to conveniently establish the escalation of computable measures from the at-one-instant processed and coeval “pixel” and the “synthesis” of the image or “frame”, to the subsequent, yet synchronous “frame per second” (FPS), and thereupon the “film” or the movement-image, and all the other more complex computable patterns such as n-dimensional “films”, either in M(s) or UTM(s). Under this scenario, however orthogonal the “synthesis” of the digital image might be, the invention is brought in computational programming terms upon, not exactly Euclidean concepts of points, planes and dimensions, neither quite to extensions such as Hilbert space, but to an overall sense of (informatic and programming) Riemannian manifold at its most complexified version. By this we mean that, symbolically and physically, the system in M(s) or UTM(s) has invariance by synchronicity in all positively-defined and non-accelerating frames of reference (“Frames Per Second” of the digital image) (FPS), and likewise the speed of light in the vacuum is the invariant non plus ultra limit of the technology.

As an example, the equation for the “density of the pixel”, measured in “pixels per inch” (PPI), that is possible to follow herein shall be the 8K Ultra Full HD, as a prior measure to comply with a fixed pixel resolution: 7680×4320 pixels. This means that an (RGB) digital color image has exactly 33.177.600 pixels disposed in a 16:9 ratio (2⁴:3² in prime factorization). Hence, each (RGB) digital color image has 796.262.400 bits, or 99.532.800 bytes. This number is the total isomorphic digital image-to-binary code to be processed by the image sensors, although it only has to discriminate 2¹ per byte/pixel, or 2^{8.3} per “pixel”, altogether processed at the same time as the “synthesis” of the digital image or “frame”. Anyway, as it will be understood by a person skilled in the art, other values of resolutions of the images in “pixels per inch” are suitable in the present invention.

At hand with the value of 99.532.800 bytes in the (RGB) “synthesis” of the image or “frame”, the next value to consider is the “Frames Per Second” (FPS). Following a conservative state of the art, it is possible to choose 60 FPS (2².3.5 in prime factorization), although, as the state of the art indicates, an astonishing record of about 4.400.000.000.000 FPS has been achieved, most welcome to the technology. Thereafter, the value of bytes per hour in the “film” or the movement-image in the computer architecture is the calculus of 60 (FPS)×60 (″)×60 (′)×99.532.800 bytes. The result is 21.499.085.000.000=2.1499085e+13.

Moreover, insofar we have encountered a bytes per hour of “film” figure within such parameters, the same thing applies to several “films” of many hours, days, years, and even “synthesis” of the image distance in light-seconds.

The value 21.499.085.000.000=2.1499085e+13 of bytes per hour in one “film” only (2.1499085e+25 Terabytes, or 21.499085×10¹⁵ Zettabytes), has now to be matched in accordance with the overall number of digital images to be processed. These images correspond to literally all the FPS of all digital images from all media and sources on the Internet and digital terrestrial television (DTTV in all the broadcasting standards: DVB-T, ATSC, ISDB-T, and DTMB). Simplifying, expectations are that the overall total data in 2025 will be of 175 Zettabytes (175×10²¹ bytes). Accordingly, one such value corresponds to 2.025463e+19=2025463×10¹³ Zettabytes/hour, which we can roughly define as the “overall task” of the present invention, most preferably in distributed partial U-machines over Turing-machines.

According to these examples, one hour of one “film” in the technology under the cited parameters, has the processor and calculus power of 21.499085×10¹⁵ Zettabytes. This is, by itself, 1.2285191e+14 times more than the appointed anticipated global data for the year of 2025. In reality, it would be necessary a period of 120 years with 175 Zettabytes of global data with a growth rate of 100%/per year to approximate the power of computational performance of the technology for the value of one “film” of one hour only.

In fact, as the present invention deals with super-computation, with 48.611.111 Terabytes per second (4.8611111×10¹⁹ bytes per second), which sums up 2⁶⁵⁻³⁹⁷⁹² per second for 175 Zettabytes of global data under the CA (estimation for the year 2025), the technology itself is, in its most incipient state, already above the capacity of a 64 bits architecture. Likely, it should improve well above 1 Exbibyte (EiB)=2⁶⁰ or 1024⁶. It is worth to say that this does not affect the network of Turing-machines on the Internet, neither the UTM(s) processing on its own, but only the implausible possible escalation to building Turing-machines only, under the technology CA on the Internet, thereof void of UTM(s).

One only “film” of one full day-time in the technology processed by the present invention, from the previous and raw illustrated calculus of pixel resolution in the “synthesis” of the image, and therefore in the “film”, preferably processed by the UTM(s) interconnected in a network of networks, shall be equivalent to 5.1597804e+17 Zettabytes (21.499085×10¹⁵×24). This is as shown but, in truth, what is expected with the technology is the parallel processing of many, many hours, days, and years of “film”, i.e., many “tapes” in the sense of a Turing-machine or U-machine, of many “films”.

As for now, inasmuch as it is remarked that one full day of one only “film” in the technology is 1.2285191e+14 times the value itself of 175 Zettabytes (estimation of global data for 2025), it is worthwhile then to equate super-computation with the technology. Consistently, in the CA model the “cell” is now the “pixel”, the chip is the “synthesis” of the image or “frame”, the card is therein each repeated FPS, the node card is the “film”, being the cabinet the various parallel “films” computed, and comprehensively the “system” as a whole the technology in U-machines, most preferably interconnected with communications networks on the Internet, over M(s).

In this context also, it has to be recalled that with these numbers these examples are assessing the conservative value of 60 FPS in 8K resolution. In point of fact, an astonishing number of about 10.000.000.000.000 FPS (Frames Per Second) has been achieved, which in fact permits instantaneous light patterns recording with Compressed Ultrafast Photography (CUP). As one would expect, this technology is most welcome so to constitute the camera/computer processor in one singular and/or multiple-nodes/servers CA, either single or interconnected with communications networks, on or outside of the Internet, but preferably on as many as possible camera/computer processors nodes/servers on the Internet, i.e., UTM(s) on the Internet over a network of Turing-machines.

We can compare the estimation of total information (audio, video, and text) of the year 1999, which is 12 Exabytes, with the correspondent conversion of information (audio, video, and text) expected in the world for the year of 2025, which is 175 Zettabytes. Now, imagining 175 Zettabytes to be run in total at the same year of 2025 under UTM(s) in a network of communications on the Internet in the technology, figures are that the overall processing at one second under the CA for the cited year of 2025 would correspond to 1.8446744e+38 times the total information (audio, video, and text) of the year 1999.

The processing value of 21.499085×10¹⁵ Zettabytes of one only “film” of one-hour in the CA is, by itself, 1.2285191e+14 times more than the total global amount of information (audio, video, and text) of the year 2025. Indeed, one second of the referred one only “film” would be capable of processing 5.9719681e+12 Zettabytes. By comparison, the estimation of total information (audio, video, and text) of the year 1999, which is 12 Exabytes, equates 0.0138350580552816 Zettabytes only. This apparently impossible achievement operated by the CA according to the present invention is made possible essentially because the information (audio, video, and text) is being matched with high resolution pixelized digital images, at (FPS)/frame rate, ergo compressing information into the “film”.

Once the model of the CA pertains to the model of super-computation, it is worthwhile to invoke the number one fastest supercomputer in the High Performance Linpack (HPL) benchmark, as of November 2019, which is the Summit or OLCF-4. Independently of its overall features, what is here proposed is its number of nodes—4.356—parallel argument with a speculative approximative equal number of UTM(s) or computer processing/camera nodes/servers over a network of communications, on the Internet, wherein the present invention is chosen to be, along the lines of the argument, of 5000 to be implemented in the CA. More details of the Summit or OLCF-4 are described in The Summit supercomputer specifications and features: Processor: IBM POWER9™ (2/node); GPUs: 27,648 NVIDIA Volta V100s (6/node); Nodes: 4,608; Node Performance: 42 TF; Memory/node: 512 GB DDR4+96 GB HBM2; NV Memory/node: 1600 GB; Total System Memory: >10 PB DDR4+HBM+Nonvolatile; Interconnect Topology: Mellanox EDR 100 G InfiniBand, Non-blocking Fat Tree; Peak Power Consumption: 13 MW.

Having the Internet at present around 50.000.000.000 nodes, well above the interval from 10²² to 10²⁴ FLOPS of all the existent computers (2015), and thus setting up a provisory number of 5000 (1:10.000.000) computer processing/cameras UTM nodes/servers over a network of computing machine(s) on the Internet in the CA, it is possible to cut the interval to a typical (10%-15% from 1.5 to 3 years) price and energy cut in the industry to the new interval from 3×10²⁰ to 1.5×10²¹, bearing approximately the same value of nodes in total, in comparison with the supercomputer Summit or OLCF-4. Therefore, it is possible to calculate the provisory speculative value of (2×22×5.000)=220.000 network communication nodes/servers in the CA of the present invention, run by UTM(s) over computing machine(s) on the Internet.

In order to find a plausible measure of bytes per FLOP (B/F), or the intensity of the required memory per unit of performance in the CA according to the invention, it is legitimate then to follow along the calculation of FLOPS. First, it is estimated an arbitrary conservative pattern (70%) of the total estimated information for the year of 2025 (1.75×10²3 Bytes), which is 1.225×10²³ (1.225e+23) bytes. It is possible to describe this value as the total product of the colour-instructions—“pixel” and the “synthesis” of the image, or “frame”, to be read in the CA. Following, it is possible, still very conservatively, to assume 60 Hz of average frequency rate in the CA running with 8k Ultra Full HD. In this background, the applied formula:

$$\approx FLOPS = 220. * \frac{60}{1} * \frac{( 1.225 e + 23 )}{60}$$

points to the value of about

2.695e+28 FLOPS (in the overall with very conservative, sub-optimized variables). Considering that the Summit or OLCF-4 supercomputer runs 200 PentaFlops, if we divide 2.695e+28 FLOPS by 200×10¹⁵ FLOPS, we find the value of 134.750.000.000 equivalent-to-Summit supercomputer overall FLOPS power distributed over many partial UTM(s) computer processing/camera nodes/servers over many M(s) on the Internet in the CA, along the sub-optimized values (pixel resolution, FPS, Hz, and mainly linear accounting one “film” only in the CA) for the estimated value of total information data of 175 Zettabytes for the year 2025. In one such setup, 24 hours (60 Hz×60″×60′×24), being equivalent to 5184000 FPS, would have, very conservatively, the CA according to the invention working with full 175 Zettabytes, a value of about 7.4861111e+25 FLOPS/day (about 2.695e+28 FLOPS÷12÷30) for one only “film” in the technology.

The results have shown, however, that, in abstract, one hour of one only “film” in the CA according to the invention accounts for 21.499085×10¹⁵ Zettabytes/hour, which implies that, equating the figures with the classical goal of 1 byte/1 FLOP, we would rather say that the CA runs (21.499085×10¹⁵÷60÷60) 5.9719681e+12 bytes/second, and that, consequently, the value in abstract of bytes/second in the CA exceeds the 2.695e+28 FLOPS provided by the 175 Zettabytes estimation of total data information for the year 2025.

Even so the calculations tell us that the CA with 175 Zettabytes as estimated data for the year of 2025 which runs at 7.4861111e+24 FLOPS/second (2.695e+28 FLOPS÷60÷60), and also that the technology of one only “film” in abstract runs 5.9719681e+12 bytes/second, hereof void of multiplication of nodes/servers over a network of communications, we can only speculatively commensurate the abstract value (bytes/second) of one only “film” in the CA of, in principle, one node only over many partial and distributed UTM(s) nodes/servers over a network of communications with Turing-machines, on the Internet, with the result of linear improvement of floating point operations per second over the same network, if considered more and more partial distributed UTM(s) nodes/servers. At hand with a value per node, the likely scenario is, by contrast, the existence of many days of “film” and many tapes of different “films” in the technology, over a network of communications in massive parallel computation by UTM(s). This is so even if there are downsize factors, apart from pure implementation factors (energy, price), embedded in the CA of the invention, like cryptography and security protocols.

In contrast, it is even possible to improve the density of work and computer performance in the CA of the invention, by way of using the technology smoothly. Instead of recurring to all the global data (created, stored, and replicated) the implementation of the technology could be initially directed to, say, replicated data only. Whilst this is not desirable, very much the contrary, i.e., as many extant and existent data is welcome, even the estimated scaled up values for the decade come short in relation to the computational power of the CA. In fact, considering that for the year 2020 the global data was, roughly, 40 Zettabytes, and reassessing that, in abstract and with the parameters introduced, one hour of one only “film” in the technology (with very conservative parameters) accounts for 21.499085×10¹⁵ Zettabytes, it would be necessary to have for one hour of one only “film” in the CA, as many as 5.3747713e+14 (21.499085×10¹⁵÷40) times one such year of global information data as 2020. Even though, there are possible improvements in the CA of the invention to mitigate the very low density of the computation performance, such as the use of metadata for every type of information (audio, image/video, and text).

Another advantage of the invention is the inherent economy of the CA that renders data on the Internet and M(s) to processing power at disposal for each UTM node, and the use of call-by-function URL Internet address or metadata signatures, thus with eased cache and volatile random-access memory requirements.

Therefore, what is relevant is, within the proper computer power of the CA according to the invention, not only the computer processing/camera image sensing (1), but also machine learning image generation (2) to ameliorate the data information volume (audio, image/video, and text) at disposal. This is why cryptography is also relevant in the preferred embodiments of the invention as it constitutes, by itself, an image generator processing power. The need is, however, to have at UTM(s) over the network of communications on the Internet, not only as much as possible increasing volume of information (audio, image/video, and text) from every camera and graphical interface at each Turing-machine (4, 6), over-generated by correspondent cryptography mathematical keys in UTM(s), but also proper methods of artificial intelligence and machine learning image generation techniques run by UTM(s) in a network of communications, in the CA of the invention.

The technology at this instance above referred is n-dimensional because no possible programming coordinate or algorithm can truly specify the conjoint dimensions of the network of communications, nor any other “pixel” whatsoever in the same topology of network, except by the method of diagonalization proper of computation and programming. Because the degree of freedom of the “pixel” and “bytes” are very high in programming, only constraint, though, to a well-ordered “system” of modules, “frames” and “films” of reference (7-1, 7.2-8.1, 8.2), the dimensions of the “system” depend directly of the ever increasingly parameters and coordinates that the “system” in itself creates. This ought to be one of the main roles of the U-Mentalism programming language ahead, typically built over U-Mentalism Assembly language. This point is well worth the study of general interrelation between rigid Euclidean network rectangular plane-like “frame”, and n-frames quasi-cuboid-like “film” in the network physical system, in comparison to the binary code-isomorphic, yet n-dimensional manifold in the symbolic system. Because the space of Riemannian metrics on a given differentiable manifold is an infinite-dimensional space, so it seems to ideally be the informatic and programming space in the CA, but as it is dense with algebraic varieties, with continuous moduli spaces isomorphic to the binary code, it is finite-dimensional, but, again, because it has non-trivial deformations with no isometry in the system, except for the physical units of reference such as the “pixel” or the “frame”, its nature in symbolic terms might be geometric instead of topological. In other words, it is difficult to say if the CA of the invention, due to its imagetic nature, is said to have a local continuous, quasi-infinitesimal geometric structure, or if it has a global discrete moduli topology, yet with quasi-connectedness, quasi-neighboring “pixels” photon point-like between points. Due to this, it might well fit best into the proper field of geometric topology. Also, to be thought through are its proper transformations in the case of (typical) digital image wave-like impression memory processing in the CA of the invention.

Apart from the very conservative parameters introduced, it is also to underline the fact that the CA of the invention brings the turnover of data to processing power, but if, for instance, energy and price requirements are over the top, truth is that a criterion for image sensing (1) or image processing (2) types can be implemented. Along these lines, images from virtual machines, the deep web, kernel, bios and system logs, even ATM's, GPS', e-mails or instant messaging, for example, could be truncated so not to reach any UTM node/server computer processing/camera over the network of communications on the Internet.

Conjointly, it is important to remember that the CA of the present invention is purposively intended to surmount from different “films” in parallel, and from a general “system”, to an informatic (typical) digital and programming sense of n-dimensional “pixel”-point, “frame”-plane, and “bytes”-(processing) time defined network of topologized structures, by reason of the network and algorithmic properties of “synthesis”. Although distance and time in the network of UTM(s) over M(s) between “bytes” in the “system” differ for measurements made in different reference “frames”, the informatic spacetime interval is, by virtue of well-ordered “frames” and “films” in the “system”, made independent of the inertial frame of reference in which they are recorded/programmed.

All of the above is especially true in relation to wave-like physical and symbolic impression such as the proper “(typical) digital image” (3). Therefore, in the case of photonics, plasmonics, computer-brain interfaces or neuromodulations, one such case where well-ordered algorithms are dependable of programming computing methods, such as photons in electromagnetic waves (in the case of photonics or other), these are, indeed, more liable to operations of “synthesis” in the global performance of UTM nodes/servers in the network of communications.

It cannot be stressed enough the admissibility principle of all other possible units of reference in the CA of the invention. This being the case, the CA in use of measures such as the “pixel”, the “byte” or “octet”, “bit”, “HEXA” or “RGB”, or even “frame” or “film”, is revised and reshaped into any other forms. A practical example of this would be different positional HEXA-like “pixels” per line resolution or plane RGB-like digital image per “frames” resolution, while another would be the applicability of X-Calculus to the technology, hence X-variables, X-abstractions, and X-applications, to correspondent R(ed), G(reen), and B(lue). Again, the object of the invention herein presented is achieved and materialized with the inversion of the von Neumann CA, and (typical) digital image-to-binary, digital or wave-like physical-symbolic “pixel”-like exponential-proneness impression (“scanner”-like)/expression (“printer”-like) key factor on computation. In like manner, it grants, preferably, as many as possible UTM(s) over computing machine(s) over a network of communications, on the Internet, hereof both ends depicted as their most abbreviated underpinning. These features also foretell man-machine communication implementations of the CA in machine learning and Artificial Intelligence.

All of the previous is also valid in relation with (typical) digital image-to-binary electromagnetic wave-like physical-symbolic “scanner”/“impression” or “printer”/“expression” implementations. Such implementations are all backed by “pixel”-like exponential-basis proneness key factor types of embodiments, furthermore with conceivably implemented layers of CA hierarchy. With this, in the scope of the present invention, it is meant that to the existence of UTM(s) over computing machine(s) over a network of communications, on the Internet, as it is preferable with the technology, the CA also envisions, in accordance, the use of as many as necessary level-hierarchies of UTM(s) over UTM(s), in turn, over M(s).

The future ahead Assembly language and further ahead unifunctional/multifunctional programming language developed, according to the present invention, at the basis dealing with different possible “synthesis” of algebraic topologies and n-dimensional geometric topologies in the network of communications, combined with digital imaging and processing, electromagnetism and acoustics, in one all-enveloping programming design, ought to be crafted to properly expand CA (U-Mentalism) Assembly, i.e., according to Homem, Luís. What is U-mentalism? Journal of Advances in Computer Networks. Volume 7, Number 1. pp. (18-24). (2019) “( . . . ) the philosophical and programming idea that proposes a singular (one only and individual, intensional) and universal (all and wholly comprehensive, extensional), programming language which is, simultaneously, an inverted scheme of all the established computer architectures (prevalently more so the Princeton, or von Neumann, computer architecture)”.

The invention is settled to abridge the use of all of the optical data transmission, generally transmission of information using light beams and/or wave communications, to directly compute (typical) digital images, but also proper digital image sensing and imaging performance utilities and state of the art technologies. In the scope of the invention, it is considered, thus, any form of digitally isomorphic formed encoding of a “(typical) digital image” (3), capable of representing, processing, compressing, storing, and printing, which might be used to the end of the CA herein presented, i.e., as a direct input into a computer processing/camera, either an M, or preferably various UTM(s) in a network of communications, on or out of the Internet. For the present, are illustrative the CCD (charge-coupled device), the APS (active-pixel sensor) and the CMOS (complementary metal oxide semiconductor) types of electronic image sensors. These are based on MOS (metal-oxide-semiconductor) technology, the difference being CCD(s) are based on MOS capacitors, and CMOS sensors are based on MOSFET (MOS field-effect transistor). There can also be hybrid CCD/CMOS, or sCMOS used by the CA. Because each cell of the CCD image sensor is considered to be an analog device, it has to be taken into account that it, nevertheless, concurs to the constituent typical example of a digital image, inasmuch as an APS (active-pixel sensor) is an image sensor with one photodetector semiconductor device coupled with active transistors, therefore with constituent analog parts, but nevertheless recognizable as a digital image, and what is more, capable of asserting the standard of a “(typical) digital image” (3), insofar it contemplates a “pixel”-like exponential-prone basis wave-like cell, able to be directly computed by camera/image processing M(s) or UTM(s).

The same is true in relation to colour separation, or to the use of any colour filter array. Both the spectral transmittance and the demosaicing algorithm and, on the overall, the colour rendition of any colour filter array, are included as tractable by the CA according to the invention, insofar mosaics of colour filters over the pixel sensors of any image sensing technology, are extensions of the proper digital image. Also relevant is the inclusion of present edge or future technologies to be used in the CA, such as QIS (quanta image sensor), in reality a step forward from digital image into “(typical) digital image” (3), wherein the sub-diffraction-limit photodetectors, henceforth “jots” instead of “pixels”, remain to be read into binary isomorphic code, whatever the values might be, even though a solution to an exponential-prone basis suchlike the “pixel” would have to be found similarly in a “megajot”, combined with FPS rate, “cell”-like unit or alike.

As illustrated in 7 and 8 in what regards implementation of the CA with reference to the “system” in the CA, it is relevant to characterize the bridge to a U-mentalism Assembly programming. Towards this end, the present invention first demarcates in a forward-looking valuation, U-mentalism Assembly programming and, consequently, U-mentalism programming language (7, 8), both in the “system”. A great difference of U-Mentalism Assembly is that it is, in part, an inevitable delineation of the proper CA. In what relates to U-Mentalism Assembly, there are, in turn, two boundaries to be settled in. These are: “U-mentalism Assembly scanner” (7.1-8.1), “(typical) digital image” sensing, photo-sensible, or wave-like impression, and “U-mentalism Assembly printer” (7.2-8.2), “(typical) digital image” (3) processing, photo-emission, or wave-like emission.

Other possible designations for the latter are “U-mentalism Eye” (7.1-8.1) and “U-mentalism Brain” (7.2-8.2). These denominations account for their different set of features in touch with the functional anatomy of the human body. More specifically, with “U-Mentalism Eye”, the reception of visible electromagnetic radiation into the retina and photoreceptors, thus before its transduction through electrical signals into the optical nerve in the direction of the brain, is meant to account for the mere “impression”, hence sensing of “(typical) digital images” (3), in “scanner” approach, in the CA. With “U-Mentalism Brain”, it is thereafter the proper transduction through electrical signals into the optical nerve in the direction of the brain that accounts for the “emission”, hence processing of “(typical) digital images” (3), in “printer” approach and “reimpression”, in the CA.

In continuation, a fundamental aspect to retain is the isomorphy between the point-like in the plane unit of reference “byte” in the “pixel”, with the (typical) digital image photo or wave-like sensible/emitted, thus “sensing”/“emission” locus, the “octet”. It is, therefore, in the “octet”-“byte” wherein is set up the full symbiosis between the “scanner”, photo or wave-like sensible “U-Mentalism Eye”, and the “printer”, photo or wave-like emitted “U-Mentalism Brain”, both part of “U-Mentalism Assembly” in the CA, ahead of U-Mentalism programming language in the “system”.

“U-Mentalism Eye” to “U-Mentalism Brain” is “scanner”-to-“printer” generally wave or photo-like Assembly, and specifically (typical) digital image “octet”-“byte”-Assembly, while “U-Mentalism Brain” to “U-Mentalism Eye” is “printer”-to-“scanner” generally wave or photo-like Assembly, and specifically (typical) digital image “octet”-“byte” Assembly. What is meant herein with “Assembly” is, rightly, U-mentalism Assembly. These affirmations are valid in accordance to any other units of reference thereof implicit.

One such example of different units of measure in the proforma scheme [U-Mentalism Eye-to-Brain] [“octet”-“byte”-Assembly] [scanner-to-printer], inverse of [U-Mentalism Brain-to-Eye] [“octet”-“byte”-Assembly] [printer-to-scanner], are all the different type of unit measurements in relation to the “octet”-“byte”. Again, herein “Assembly” is, rightly, U-Mentalism Assembly. This proforma scheme, due to all possible accommodations in the CA, can be altered to all the other combinatorial examples, e.g., [U-Mentalism Eye-to-Brain] [“octet”-“Hexa”-Assembly] [scanner to printer], or [U-Mentalism Brain-to-Eye] [RGB-to-Binary “frame”-unit][printer-to-scanner], just to name two.

Within the appointed parameters for the CA, in the 8K Ultra Full HD (7680*4320), with the total of 33.177.600 pixels in a 16:9 (equivalent to 4²:3²) ratio, it is rendered clear that either the “scanner”/“sensing” or “printer”/“emission” sides, implicitly within all the units of measure in the proforma scheme, do not have to assess per se the entire value of 2^{8×3}×3×33.177.600=5.5662776e+14 photo-sensible/emitted possible variations in the RGB model in the digital image in specific terms of the referred implementation, nor the eventual other result in shift with other units of reference, but only locally, at each “octet” in each of the 3 “bytes” in the “pixel” the 256 (0-255) possible variations of RGB colour, and the exact same like for the eventual other result in shift with other units of reference in the CA, such as in “(typical) digital image” (3) wave-like “sensible”/“scanner” or “emission”/“printer” units of reference applied to the “system” of UTM(s) on M(s), possibly with photonics, plasmonics, computer-brain interfaces, and even quantum computing.

While these last remarks are valid, the referred proforma scheme at U-mentalism Assembly level must undergo an informatic programming version of the general theory of arithmetic, thereof present in RGB, HEXA, the binary code, likewise suitable to machine learning and AI. This encoding is nothing more than the n^{th} order of all the “pixel”-derived “bytes” sequences, but mainly of the “frame” (e.g. 99.532.800 “bytes” for an 8K Ultra Full HD digital image) for all possible collections of “frames” in “films”. However it is recommended the use of such collections in “U-mentalism Brain”, that is, on Assembly “printer”-to-“scanner” elevating from simple “octet”-“byte”-Assembly to Assembly-to-Assembly in the computer architecture, the foremost most prior advisable parameters use in U-mentalism Assembly is, naturally, in “U-Mentalism Eye” “octet”-“byte”-Assembly recollection firsthand, “scanner”-to-“printer” recollection of well-ordered “pixel”-derived bytes sequences, digital images “frames”, and “films”, to the end of posterior use in “U-mentalism Brain”. Herein the interpolated use of HEXA and RGB, along the binary code in dialogue with U-mentalism Assembly, either in “U-mentalism Brain” collections, or leading by the need of recollection in “U-mentalism Eye”, is not only possible, but also to be favored.

The basis of this understanding and use of U-mentalism Assembly in machine learning and AI is, of course, the fundamental theorem of arithmetic (namely with the use of arithmetic definition through prime numbers) and the positional numeral system, not only in the sense of any base of the Hindu-Arabic numeral system, by contingence of the use of non-numerals, yet positional, symbols in HEXA, nor because of the Cartesian nature of RGB, however whence they are combined is the binary code system, but essentially due to the fact that the well-ordered “U-mentalism Eye” recollections and thereof programming use in “U-mentalism Brain” collections apply broadly to “frames” and n^{th} possible constructed “films” in the CA, run preferably by UTM(s) over a network of communications over M(s) on the Internet.

As used in this description, the expressions “about” and “approximately” refer to a range in values of roughly 10% the specified number.

As used in this description, the expression. “substantially” means that the real value is within an interval of about 10% of the desired value, variable or related limit, particularly within about 5% of the desired value, variable or related limit or particularly within about 1% of the desired value, variable or related limit.

The subject matter described above is provided as an illustration of the present invention and must not be interpreted to limit it. The terminology used with the purpose of describing specific embodiments, according to the present invention, must not be interpreted to limit the invention. As used in this description, the definite and indefinite articles, in their singular form, aim to include in the interpretation the plural forms, unless the context of the description explicitly indicates the contrary. It will be understood that the expressions “comprise” and “include”, when used in this description, specify the presence of the characteristics, the elements, the components, the steps and the related operations, but do not exclude the possibility of other characteristics, elements, components, steps and operations from being also contemplated.

All modifications, providing that they do not modify the essential features of the following claims, must be considered within the scope of protection of the present invention.

### INDUSTRIAL APPLICABILITY

The method and the CA of the present invention offers an exponential gain of partial computable functions over every possible domain of study. Its scientific and technical applicability can be demonstrated, for example, in satellite image processing, aerodynamics, hydrodynamics, thermal and fluid objects, with strong impact in various areas in a new level cybernetics.

### REFERENCE SIGNS LIST

1—illustrates an embodiment comprising network communications or Internet data: image/text “pixel”-composed images or general image sensing”;
2—illustrates another embodiment comprising network communications AI and cryptographic data: image/text “pixel”-permuted/combined images or general image processing;
3—illustrates a (typical) digital image in the context at or near the speed of light (typical) digital image-to-binary singular or multiple nodes/servers CA;
4—illustrates general Turing-machine tape data;
5—illustrates a partial distributed and decentralized horizontal massive parallel computation network, preferably on the Internet, comprising UTM(s) camera/image processing nodes/servers;
6—illustrates a pool comprising of (typical) digital images, comprising photo (FPS) images, URL(s) and Web pages (FPS) images, e-mails and instant messaging (FPS) images, mobile and tablet frame (FPS) images, digital tv and film (FPS) images, outdoors and consoles (FPS) images, virtual machines and the deep web (FPS) images, kernel, bios and system logs (FPS) images, ATM's, GPS, s, CCTV, drones, automated AI and machine learning (FPS) images;
7—illustrates U-Mentalism Assembly programming both instructions and algorithms different (module octet-byte) isomorphic to the binary code (typical) digital modules, (FPS) images and films, either composed or permuted/combined;
7.1—illustrates the embodiment of U-Mentalism Assembly programming comprising of U-Mentalism Assembly scanner-to-printer or Eye-to-Brain well-ordered composition recollection of “synthesis” of modules, (FPS) frames, and/or films, general blocks or stacks in sequential massive parallel computation;
7.2—illustrates the embodiment of U-Mentalism Assembly printer-to-scanner or Brain-to-Eye well-ordered collection of anew permuted/combined “synthesis” of modules, (FPS) frames, and/or films, general blocks or stacks in sequential massive parallel computation;
8—illustrates the embodiment of the previous U-Mentalism Assembly programming comprising of both U-Mentalism Assembly scanner-to-printer or Eye-to-Brain well-ordered composition recollection of “synthesis” of modules, (FPS) frames, and/or films, as well as U-Mentalism Assembly printer-to-scanner or Brain-to-Eye well-ordered collection of anew permuted/combined “synthesis” of modules, (FPS) frames, and/or films;
8.1—illustrates the embodiment of the previous U-Mentalism Assembly programming comprising of U-Mentalism Assembly scanner-to-printer or Eye-to-Brain well-ordered composition recollection of “synthesis” of modules, (FPS) frames, and/or films, general blocks or stacks in sequential massive parallel computation being, in loop fashion, allocated and reimpressed into UTM(s);
8.2—illustrates the embodiment of the previous U-Mentalism Assembly programming comprising of U-Mentalism Assembly printer-to-scanner or Brain-to-Eye well-ordered collection of anew permuted/combined “synthesis” of modules, (FPS) frames, and/or films, general blocks or stacks in sequential massive parallel computation being, in loop fashion, allocated and/or reimpressed into UTM(s);
9—illustrates a general block diagram with actions boxes related to each block of the process, which process is in massive parallel computation and in loop fashion;
9.1—illustrates the box of conversion of (typical) digital images, by which the density of the “pixel” or “pixel”-like equation in accordance with the number of pixels or “pixel-like” “cells” equates image resolution conversion, generally an M to UTM or UTM only protocol, which processes in massive parallel computation and in loop fashion;
9.2—illustrates the box of impression memory of (typical) digital images comprising of (FPS) image/text RGB/binary isomorphic “pixel” or “pixel”-like digital images, thus allocated in data/metadata, generally an UTM to M and UTM only protocol, which processes in massive parallel computation and in loop fashion;
9.3—illustrates the box of processing (typical) digital images comprising of (FPS) image/text RGB/binary isomorphic “pixel” or “pixel”-like digital images in the form of data/metadata, generally an UTM to UTM protocol, which processes in massive parallel computation and in loop fashion;
9.4—illustrates the box of least-to-the-furthest well-ordering recollection of (module 8 bits or 1 byte) (typical) digital images comprising of data/metadata RGB/binary isomorphic “pixel” or “pixel”-like composition modules, (FPS) frames, and films, equivalent to U-Mentalism scanner-to-printer or Eye-to-Brain, generally an UTM to UTM protocol, which processes in massive parallel computation and in loop fashion;
9.5—illustrates the box of least-to-the-furthest well-ordering collection of (module 8 bits or 1 byte) (typical) digital images comprising of data/metadata RGB/binary isomorphic “pixel” or “pixel”-like permutation/combination modules, (FPS) frames, and films, equivalent to U-Mentalism printer-to-scanner or Brain-to-Eye, generally an UTM to UTM protocol, which processes in massive parallel computation and in loop fashion;
9.6—illustrates the box of reimpression memory of (typical) digital images comprising of (FPS) image/text RGB/binary isomorphic “pixel” or “pixel”-like digital images, thus previously composition recollected or Eye-to-Brain, and permuted/combined collected or Brain-to-Eye, well-ordered allocated in data/metadata, of which whenever computation prerequisites only recollection well-orderings can be reimpressed, generally an UTM to UTM only protocol, which processes in massive parallel computation and in loop fashion;
9.7—illustrates the box of programming processing of algorithms comprising of both well-ordered composition recollections, but fundamentally well-ordered permuted/combined collections of (module 8 bits or 1 byte) (typical) digital images comprising of data/metadata RGB/binary isomorphic “pixel” or “pixel”-like digital images, (FPS) frames, and films, generally an UTM to UTM protocol, which processes in massive parallel computation and in loop fashion;
CO—illustrates the conversion of (typical) digital images;
FL—illustrates the flux of (typical) digital images to UTM(s), whereby, either from general image sensing or general image processing, (module 8 bits or 1 byte) image/text (typical) digital images comprising of data/metadata RGB/binary isomorphic “pixel” or “pixel”-like modules (modules 8 bits or 1 byte) (FPS) frames, and thus films of digital images;
MA—illustrates massive parallel computation;
LO—illustrates a loop mechanism;

### CITATION LIST

Citation List follows:

### Patent Literature

PTL 1:—

### Non Patent Literature

NPL 1: Turing, A. M. On Computable Numbers, with an Application to the Entscheidungs problem. (1936)
NPL 2: Backus, John W. Can Programming Be Liberated from the von Neumann Style? A Functional Style and Its Algebra of Programs. (1977)
NPL 3: Cook, Stephen. The complexity of theorem proving procedures. Proceedings of the Third Annual ACM Symposium on Theory of Computing. (1971) pp. 151-158
NPL 4: von Neumann, John. First Draft of a Report on EDVAC, Moore School of Electrical Engineering, University of Pennsylvania, Jun. 30, 1945, p. 32
NPL 5: The Summit supercomputer specifications and features are: Processor: IBM POWER9™ (2/node); GPUs: 27,648 NVIDIA Volta V100s (6/node); Nodes: 4,608; Node Performance: 42 TF; Memory/node: 512 GB DDR4+96 GB HBM2; NV Memory/node: 1600 GB; Total System Memory: >10 PB DDR4+HBM+Nonvolatile; Interconnect Topology: Mellanox EDR 100 G InfiniBand, Non-blocking Fat Tree; Peak Power Consumption: 13 MW
NPL 6: Homem, Luis. What is U-mentalism? Journal of Advances in Computer Networks. Volume 7, Number 1. pp. (18-24). (2019).

1. A method to perform computation at or near the speed of light (typical) digital image-to-binary Computer Architecture (CA), which is the pixel or any “pixel”-like exponential-prone basis single “cell” in a digital image including numeric representation, and comprising the following steps:
a. converting (typical) digital images (3) to a predetermined density of the pixel equation, or image resolution, resulting in a set of converted digital images (9.1);
b. impressing memory of image/text RGB/binary “pixel”-like isomorphic (typical) digital images allocated in numerical data or metadata, resulting in a set of allocated numerical data or metadata (9.2);
c. processing the image/text RGB/binary isomorphic allocated numerical data or metadata of the (typical) digital images, resulting in a set of processed digital images (9.3);
d. well-ordering recollection of the image/text RGB/binary isomorphic processed (typical) digital images from the least-to-the-furthest well-ordered numeric representation of the digital images, resulting in a set of well-ordered digital images composition (9.4), and whenever computation pre-requisites only recollection well-orderings can be reimpressed (9.6);
e. well-ordering collection of the image/text RGB/binary isomorphic processed (typical) digital images from the least-to-the-furthest numerical and algorithmic representation, resulting in a set of well-ordered digital images collection (9.5);
f. reimpressing the image/text RGB/binary isomorphic processed and well-ordered (typical) digital images, resulting in numerical data or metadata (9.6);
g. programming of image/text RGB/binary isomorphic processed and well-ordered algorithms based in numerical data or metadata (9.7); and
wherein the numeric representation of the (typical) digital image (3) is always RGB/binary or “pixel”-like photon/binary code isomorphic with the imagetic information, such as in the state of the art the RGB image/text colour model; and
wherein the steps a) is executed by a Turing-machine (M) to Universal Turing-machine (UTM) protocol, or Universal Turing-machine (UTM) protocol only and b) is executed by an Universal Turing-machine (UTM) to Turing-machine (M) protocol and Universal Turing-machine (UTM) protocol only; and wherein the steps c), d), e), f), and g) are executed by an Universal Turing Machine (UTM) to Universal Turing-machine (UTM) protocol; and
wherein computation is performed at each node/server in a communication network of Universal Turing Machines (UTMs) over Turing Machines (Ms) in a) to g) loop massive parallel computation.

2. The method to perform computation at or near the speed of light according to the claim 1, wherein every UTM is a camera/image-processor node/server able to compute digital image information or any (typical) digital image interface.

3. The method to perform computation at or near the speed of light according to claim 1, wherein the Turing-machine is any computing machine that has a processor and/or a text/image output device.

4. The method to perform computation at or near the speed of light according to claim 1, wherein the Turing-machine is selected from a group comprising of personal computers, desktop devices, mobile devices, Internet servers, clusters, warehouse-scale mainframe computers, embedded computing machines, GPU game consoles, cloud computing, digital tv boxes, outdoors, drones, CCTV, ATM's, GPS.

5. The method to perform computation at or near the speed of light according to claim 1, wherein the processing c) and g) of the digital images is executed into one or more elements of the group comprising of graphic processing units (GPUs), general-purpose central processing units (CPUs), and highly massive parallel computation systems.

6. The method to perform computation at or near the speed of light according to claim 1, wherein the density of the pixel equation in accordance with the number of pixels, in the step a) of conversion of (typical) digital images to a pre-determined required image resolution conversion, results in a set of converted (typical) digital images.

7. A computer architecture to perform computation at or near the speed of light, is characterized by the “synthesis” of the pixel or any “pixel”-like exponential-prone basis “cell” in the digital image, wherein said digital image includes numeric representation, and comprises the following instructions:
a. converting (typical) digital images (3) to a predetermined density of the pixel equation, or image resolution, resulting in a set of converted digital images (9.1);
b. impressing memory of image/text RGB/binary “pixel”-like isomorphic (typical) digital images allocated in numerical data or metadata, resulting in a set of allocated numerical data or metadata (9.2);
c. processing of the image/text RGB/binary isomorphic allocated numerical data or metadata of the (typical) digital images, resulting in a set of processed digital images (9.3);
d. well-ordering recollection of the image/text RGB/binary isomorphic processed (typical) digital images from the least-to-the-furthest well-ordered numeric representation of the digital images, resulting in a set of well-ordered digital images composition (9.4), and whenever computation pre-requisites only recollection well-orderings can be reimpressed (9.6);
e. well-ordering collection of the image/text RGB/binary isomorphic processed (typical) digital images from the least-to-the-furthest numerical and algorithmic representation, resulting in a set of well-ordered digital images collection (9.5);
f. reimpressing the image/text RGB/binary isomorphic processed and well-ordered (typical) digital images, resulting in numerical data or metadata (9.6);
g. programming processing of image/text RGB/binary isomorphic processed and well-ordered algorithms based in numerical data or metadata (9.7); and
wherein the numeric representation of the (typical) digital image is always RGB/binary or “pixel”-like photon/binary code isomorphic with the imagetic information, such as in the state of the art the RGB image/text colour model; and
wherein the steps a) is executed by a Turing-machine (M) to Universal Turing-machine (UTM) protocol, or Universal Turing-machine (UTM) only protocol and b) is executed by an Universal Turing-machine
(UTM) to Turing-machine (M) protocol and Universal Turing-machine (UTM) protocol only; and wherein the steps c), d), e), f), and g) are executed by an Universal Turing Machine (UTM) to Universal Turing-machine (UTM) protocol; and
wherein computation is performed at each node/server in a communication network of Universal Turing Machines (UTMs) over Turing Machines (Ms) in a) to g) loop massive parallel computation.

8. The computer architecture to perform computation at or near the speed of light according to claim 7, wherein every UTM is a camera/image-processor node/server able to compute digital image information or any (typical) digital image interface.

9. The computer architecture to perform computation at or near the speed of light according to claim 7, wherein the Turing-machine is a computing machine that has a processor and/or a text/image output mechanism or device.

10. The computer architecture to perform computation at or near the speed of light according to claim 7, wherein the Turing-machine is selected from a group comprising of personal computers, desktop devices, mobile devices, Internet servers, clusters, warehouse-scale mainframe computers, embedded computing machines, GPU game consoles, cloud computing, digital tv boxes, outdoors, drones, CCTV, ATM's, GPS.

11. The computer architecture to perform computation at or near the speed of light according to claim 7, wherein the c) and g) processing of the digital images is executed into one or more elements of the group comprising of graphic processing units (GPUs), general-purpose central processing units (CPUs), and highly massive parallel computation systems.

12. The computer architecture to perform computation at or near the speed of light according to claim 7, wherein the density of the pixel equation in accordance with the number of pixels, in the step a) of conversion of (typical) digital images to a predetermined required image resolution conversion, results in a set of converted (typical) digital images.
